(19) United States
(12) Patent Application Publication
(10) Pub. No.: US 2013/0275250 A1
(43) Pub. Date: Oct. 17, 2013

(54) Systems and Methods For Exchanging Gifts in Socially Focused Categories

(71) Applicant: The Next One's On Me, Inc., (US)

(72) Inventors: Sara Fae Rodell, Austin, TX (US); Jeffrey Neal Schwartz, Austin, TX (US)

(73) Assignee: THE NEXT ONE'S ON ME, INC., Austin, TX (US)

(21) Appl. No.: 13/677,299

(22) Filed: Nov. 14, 2012

Related U.S. Application Data
(60) Provisional application No. 61/559,380, filed on Nov. 14, 2011.

(51) Int. Cl. G06Q 30/06

(52) U.S. Cl. CPC G06Q 30/0601
USPC 705/26.1

(57) ABSTRACT

A method for exchanging gifts is provided. The method comprises (a) registering with a system which provides electronic tokens redeemable at any member of a set of merchants; (b) purchasing an electronic token from the service; (c) designating a gift category for the token, such that the token is redeemable for a product or service within the designated category at any member of the set of merchants which offers a product or service within the designated category; and (d) sending the token to a designated recipient via an electronic message.

### CROSS-REFERENCE TO RELATED APPLICATION

This application claims the benefit of priority from U.S. Provisional Application No. 61/559,380, filed Nov. 14, 2011, having the same inventor, and the same title, and which is incorporated herein by reference in its entirety.

### FIELD OF THE DISCLOSURE

The present disclosure relates generally to gift exchange, and more particularly to systems and methods for exchanging gifts electronically in socially focused categories.

### BACKGROUND OF THE DISCLOSURE

Various systems and methodologies are currently known to the art for gift exchange. These include the ubiquitous gift card, which is typically in the form of a physical token having a set value associated with it, and which may be applied as a credit against the cost of goods or services at a merchant associated with the gift card.

Other gifting systems currently exist as well. For example, one existing system marketed under the name GiftRocket™ allows a party to purchase for a recipient an online gift card at any of a select group of businesses. After the purchaser selects a business, the service delivers the gift electronically to the recipient's email account or Facebook wall, and sends a predetermined amount of money to the recipient via Paypal. The money may then be used at the designated business. Once the recipient is in the designated business establishment, the recipient selects a “redeem” option provided in the message, a GPS system verifies their presence in the establishment, and the funds are deposited into their PayPal account. In this approach, the recipient still pays the merchant; however, the transaction is at net zero cost to them, since they have received PayPal funds to cover the transaction.

In another known gift exchange system marketed under the name Bartab™, users pay $1 to send drinks to a friend. The friend then presents $1 to the bar to redeem, with redemptions often capped at a set number.

Still other gift exchange systems currently known to the art involve teaming approaches. For example, The Gifts Project™, FriendFund™, Giftiki™ and WePay™ are all creative gifting systems where groups team together to buy expensive objects for their friends by each contributing small amounts.

### BRIEF DESCRIPTION OF THE DRAWINGS

FIG. 1 is an illustration of a screenshot (the screenshot of FIG. 17) from an embodiment of the software disclosed herein as rendered on the display of a mobile technology platform.

FIGS. 2-21 are screenshots of the main display area from a first particular, non-limiting embodiment of a software system disclosed herein which implements a system and method for exchanging gifts (in the form of electronic gift tokens) in accordance with the teachings herein.

FIGS. 22-91 are wireframes showing the main display area from a software system of the type depicted in FIGS. 2-21, which further illustrate various features of the system.

FIGS. 92-97 are flowcharts illustrating the operation of the software depicted in FIGS. 22-91.

FIG. 98 is a diagram illustrating a tiered pricing strategy which may be utilized in the software described herein.

FIG. 99 is a flowchart illustrating the handling of NOOMs for recipients that do not have a current user account.

### SUMMARY OF THE DISCLOSURE

In one aspect, a method for exchanging gifts is provided. The method comprises (a) registering with a system which provides electronic tokens redeemable at any member of a set of merchants; (b) purchasing an electronic token from the service; (c) designating a gift category for the token, such that the token is redeemable for a product or service within the designated category at any member of the set of merchants which offers a product or service within the designated category; and (d) sending the token to a designated recipient via an electronic message.

In another aspect, a method is provided for processing payments of goods or services. The method comprises (a) registering with a system which provides electronic tokens redeemable at any member of a set of merchants; (b) receiving a request for redemption of a token issued by the system in conjunction with the purchase of goods or services; (c) accepting the request; (d) receiving payment from the system for redemption of the token; and (e) applying the payment to the cost of the requested goods or services.

In a further aspect, a system is provided for exchanging gifts. The system comprises a first set of servers which contains at least one member, each of which (a) issues, upon demand and receipt of payment, electronic tokens which are redeemable at any member of a predefined set of merchants, and (b) processes payment to a merchant selected for redemption of a token. The system further comprises a plurality of mobile technology platforms, each of which is in communication with a member of said first set of servers over a network, and each of which is equipped with a tangible medium having suitable programming instructions recorded therein which, upon execution, cause the mobile technology platform to undertake actions which result in (a) purchasing an electronic token from the service; (b) designating a gift category for the token, such that the token is redeemable for a product or service within the designated category at any member of the set of merchants which offers a product or service within the designated category; and (c) sending the token to a designated recipient via an electronic message.

### DETAILED DESCRIPTION

While the foregoing gifting systems and methodologies have many desirable attributes, existing systems and methodologies for gifting have various infirmities associated with them. For example, conventional gift cards are inconvenient in that they require the user to have the card on them at the time of redemption, and if they are lost, they cannot typically be replaced.

Other gifting systems developed to date also suffer from various infirmities. For example, the gifts offered through the GiftRocket™ system are essentially gifts of money, and hence are often perceived by consumers as being impersonal. Other gifting solutions, such as the system offered by Bartab™, are limited in scope, are geared towards purchasing at a discount, and require partial payment by the recipient. Still other solutions, such as the teaming approaches exemplified by The Gifts Project™, FriendFund™, Giftiki™ and WePay™, are directed toward less frequent, more expensive, and occasion-driven gifting. Accordingly, there remains a need in the art for new systems and methodologies of gifting that overcome these infirmities.

It has now been found that some or all of these needs may be met by the systems and methodologies disclosed herein. In a preferred embodiment, a gifting system and methodology is provided wherein a gift, in the form of an electronic token or e-currency, is delivered by email or text, and which may be redeemed for a product at participating vendors. Preferably, a set price point is established for each category that may vary by location, thereby taking into account geographical disparities in the cost of living. The person sending the gift designates a gift category within which the gift may be redeemed, and the recipient chooses a particular merchant from among the participating merchants at which to redeem the token. Preferably, selection of a merchant by the recipient occurs online by way of a mobile technology platform so that the recipient can designate the merchant at the time of redemption. The selection of a merchant by the recipient triggers a payment process to the selected merchant.

It will be appreciated that the foregoing type of system and methodology avoids the shortcomings of conventional gift cards, since the recipient is not required to carry a physical card with them. Rather, this approach leverages mobile technology platforms, the use of which has become widespread among consumers. Moreover, the recipient is not tied to a specific merchant, but is free instead to choose from among a group of merchants that offer a product or service in the designated category. On the other hand, the designation of a category makes the transaction more personal than a monetary gift.

It will also be appreciated that the foregoing type of system and methodology is better suited to small gift transactions, such as buying someone a cup of coffee or a treat. Hence, this approach would more typically involve the gifting of products or experiences that are usually given in person. On the other hand, this approach is not limited to specific products or services, such as alcoholic beverages.

Moreover, the foregoing type of system and methodology is not concerned with purchasing products or services at a discount, but is centered instead on exchanging meaningful gifts, typically at or near full price. Since the users of the system are not bargain hunting, this approach lends itself to higher total transaction amounts (even though the goods or services being gifted may be relatively inexpensive), and hence offers the prospect of a system which can attract a higher quality network of affiliated merchants.

The foregoing type of system and methodology is also preferably not directed toward large gifts. Consequently, while some approaches to gift exchange are best suited for infrequent, occasion-driven gifting, the current approach reflects the value proposition that gifts do not have to be big to be appreciated, and is conducive to frequent gift exchanges.

Finally, the foregoing type of system and methodology may advantageously leverage social media platforms, such as Facebook, as part of the gift-exchange experience.

The electronic tokens utilized in the systems and methodologies described herein transform from an electronic gift to a real product upon redemption. In a preferred embodiment, users access and gift these tokens from a client resident on their mobile technology platform or by accessing a website. The tokens are preferably offered in specific categories (such as treats/beer/bar & bites) at fixed price points that vary by city. The tokens may be redeemed for products within their categories at any affiliated merchant.

Preferably, the tokens utilized in the systems and methodologies described herein have two components: the product (or service) being gifted, and the gift message. The system separates these components upon delivery. The product is deposited into a token bank associated with the recipient, where it then functions as a currency that is redeemable at any participating merchant. As an optional component, the gift message is logged into the recipient's transactional history, allowing recipients to reference who sent the gifts and any recommendations regarding gift redemption. In some embodiments, the tokens may be utilized by merchants and large businesses as a CRM tool.

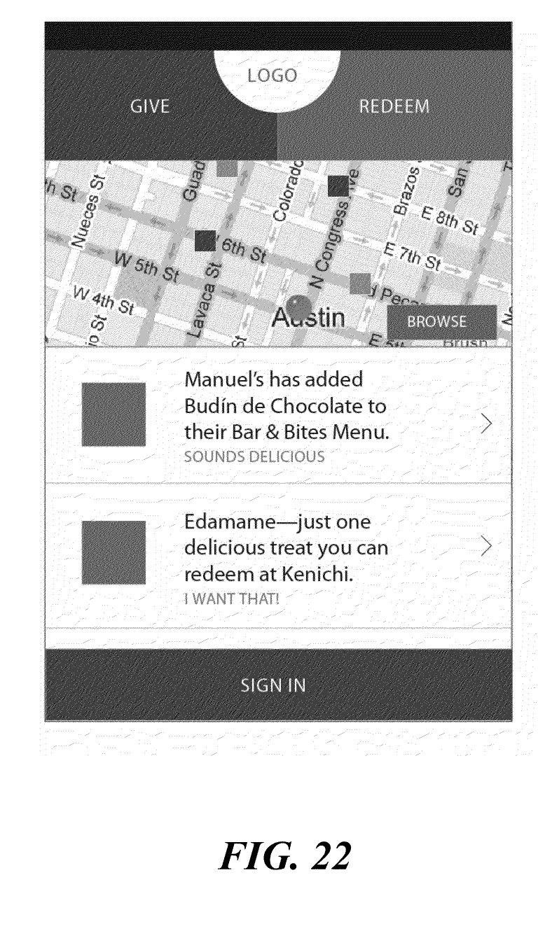

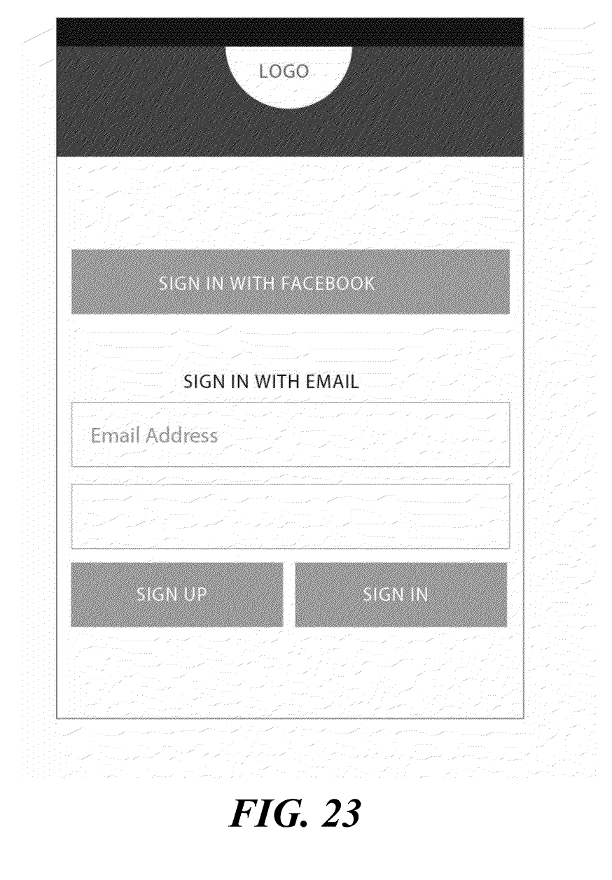

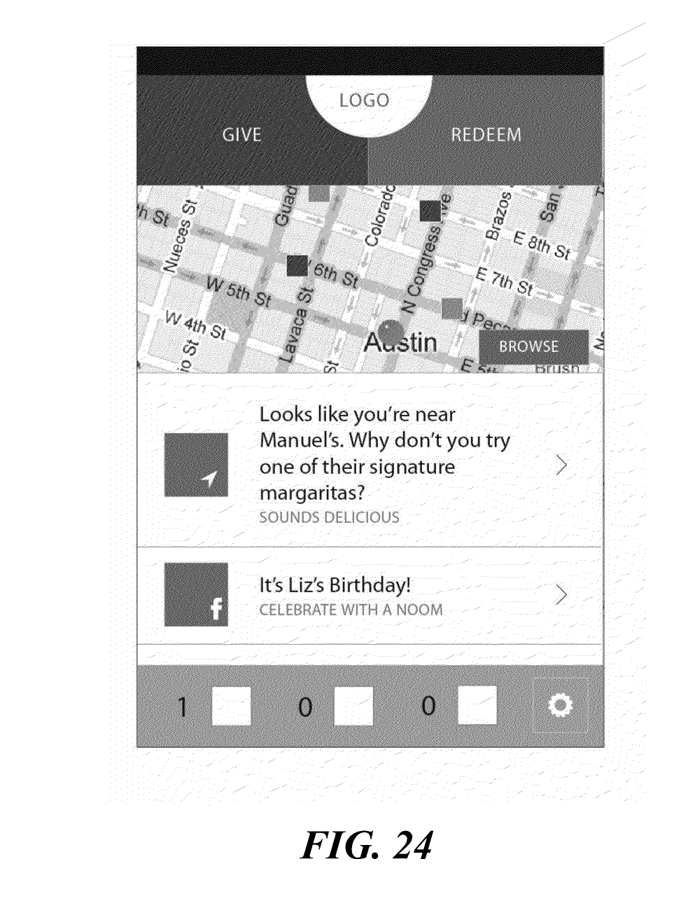

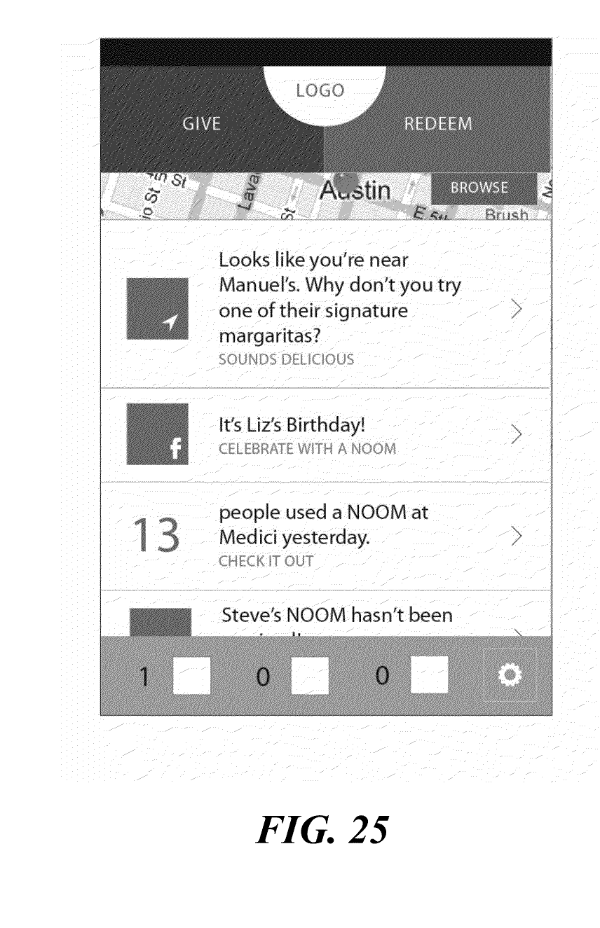

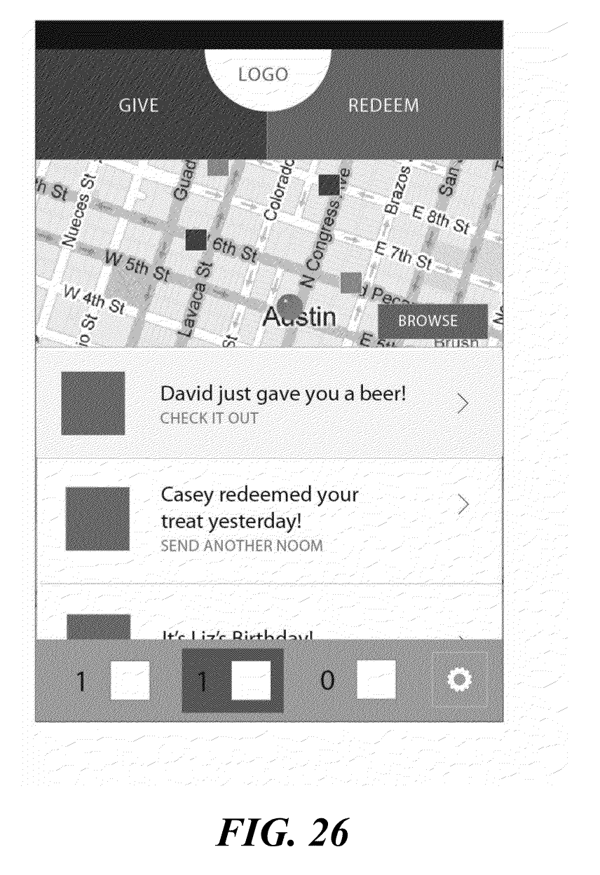

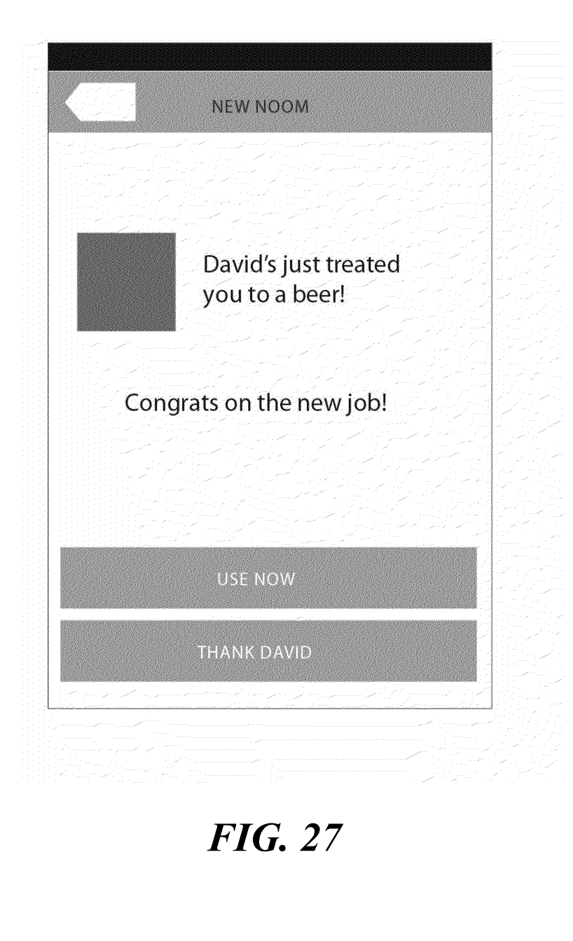

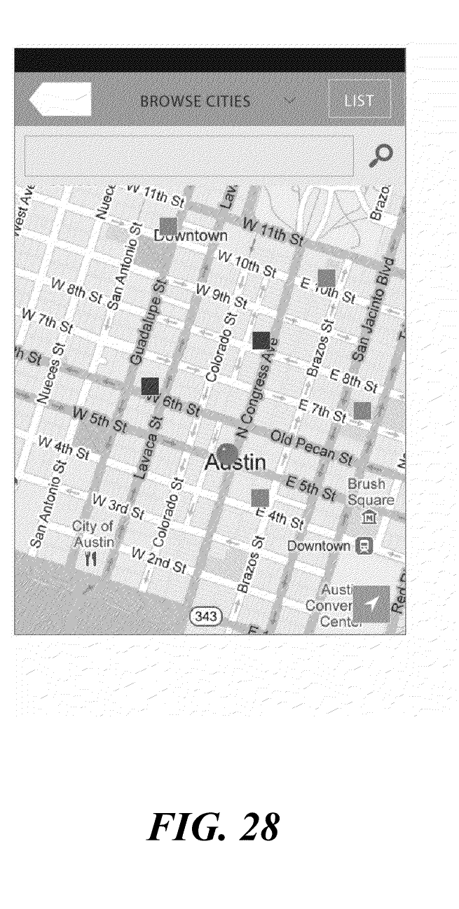

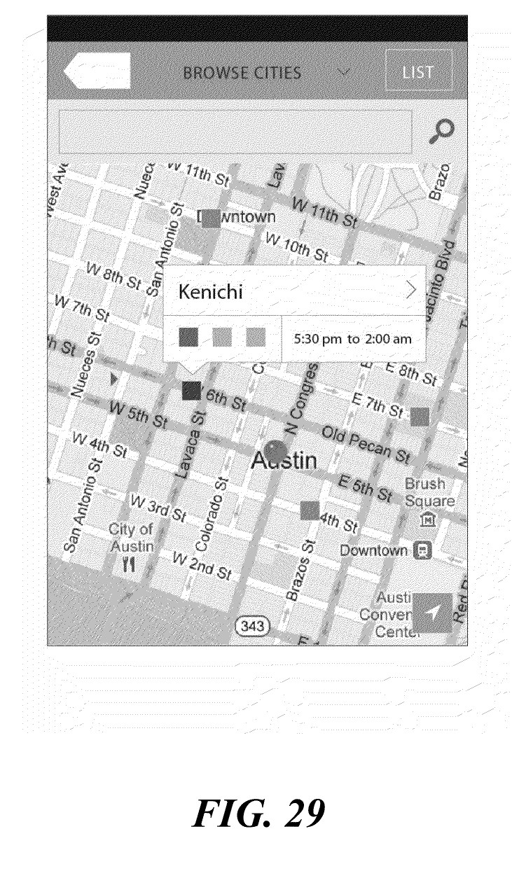

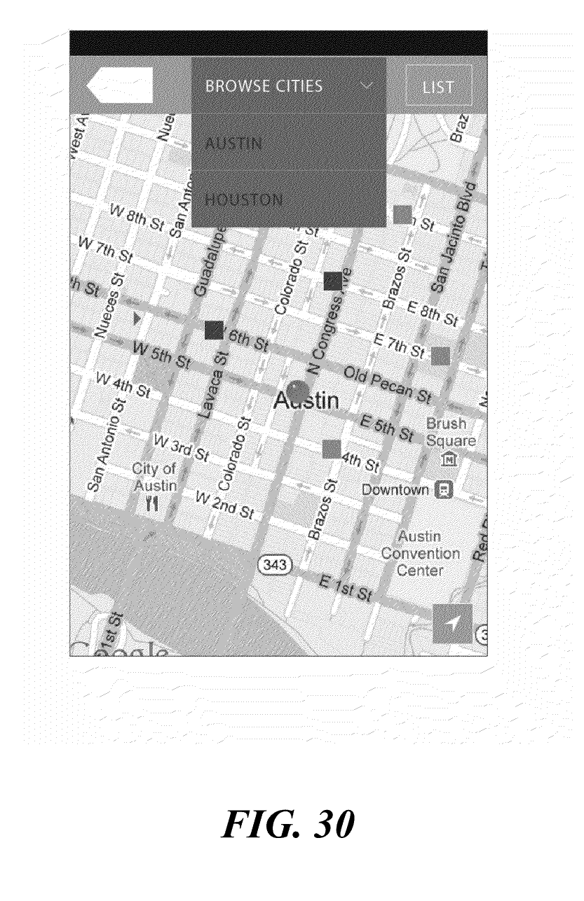

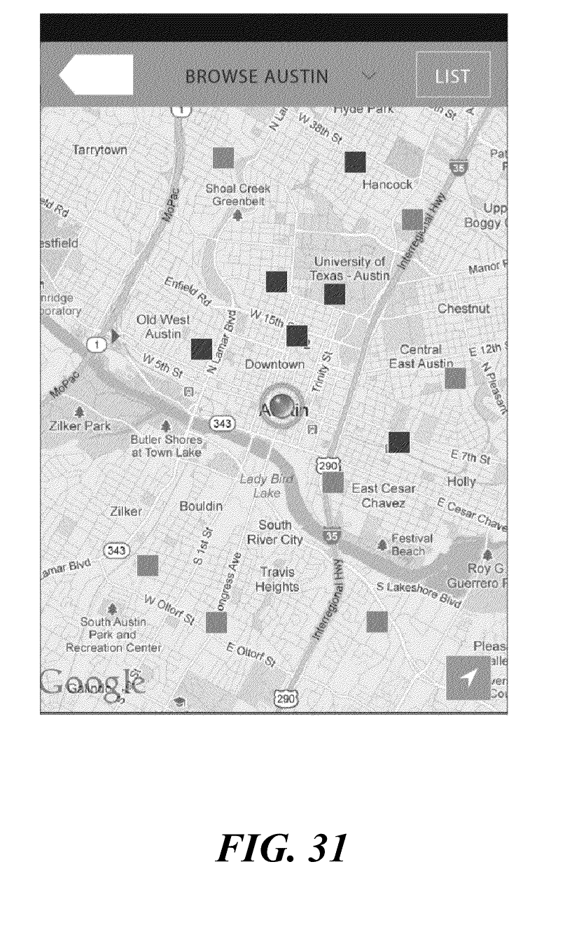

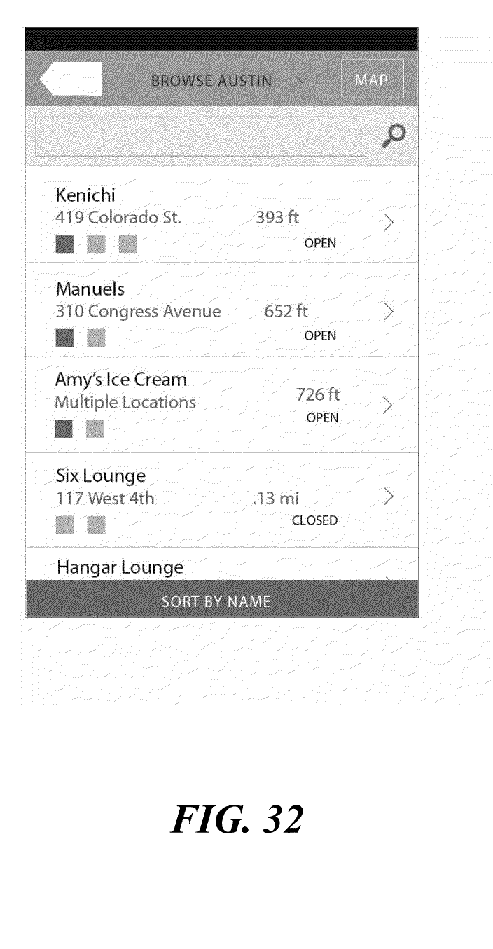

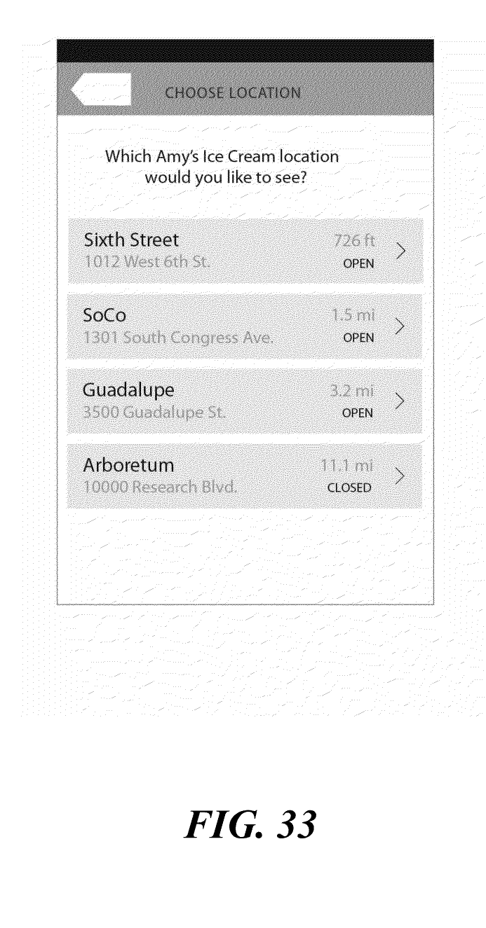

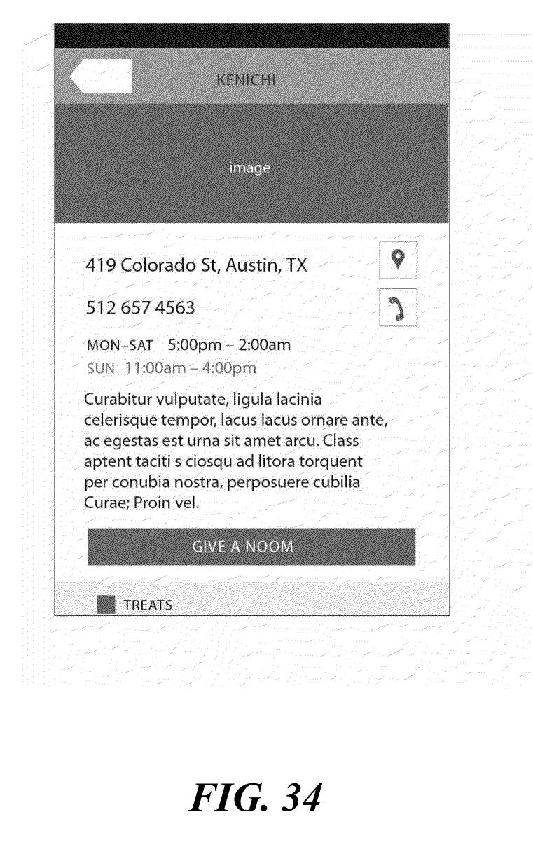

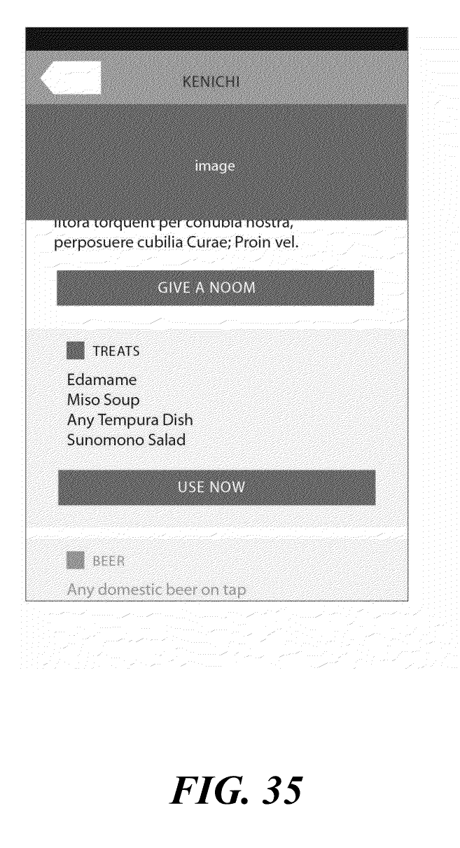

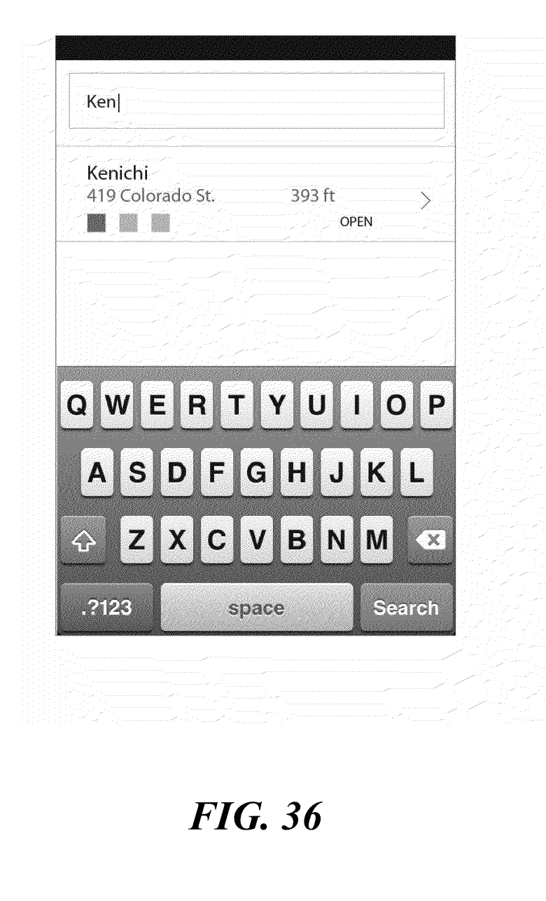

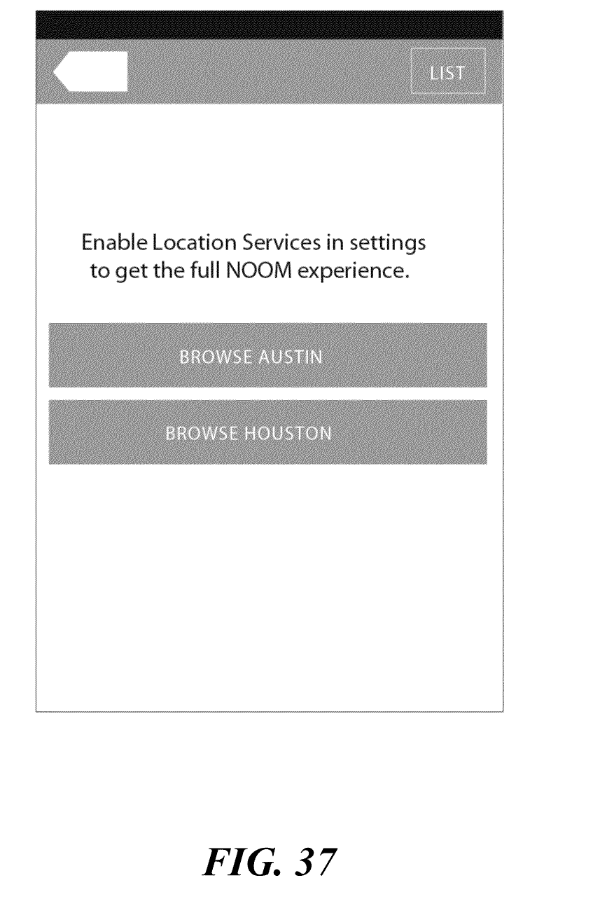

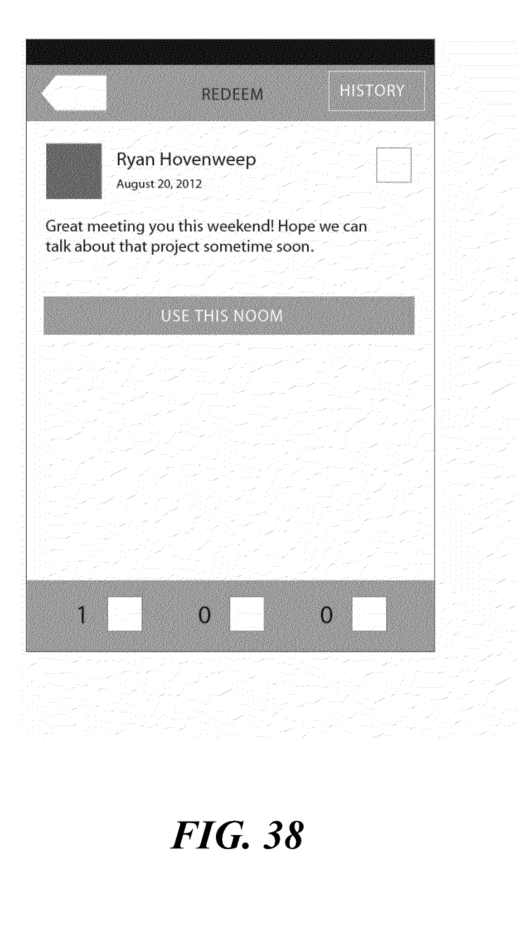

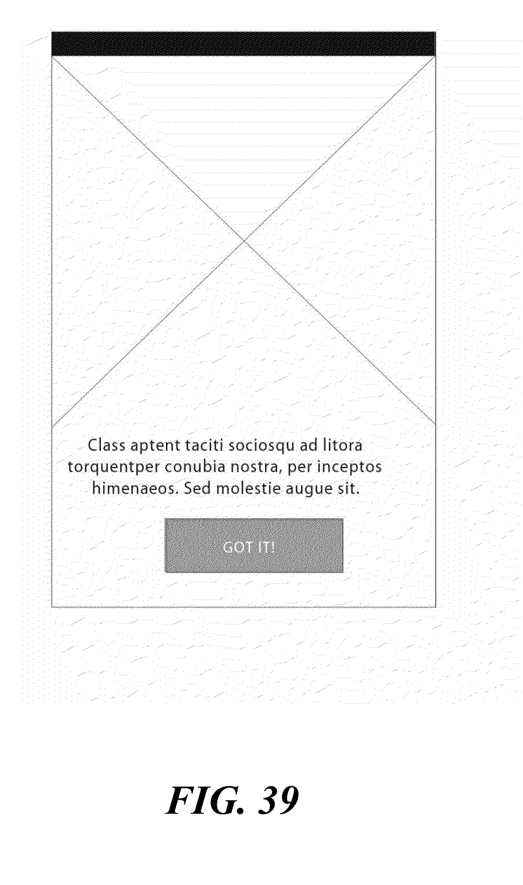

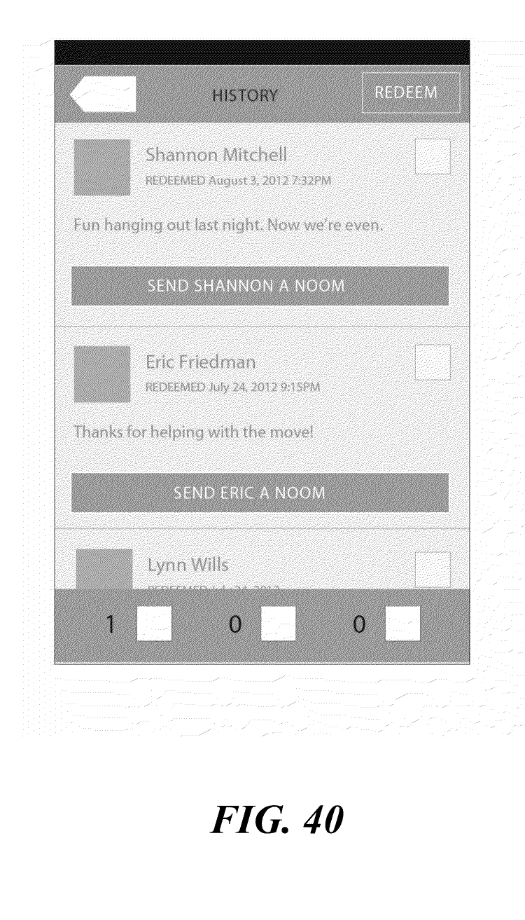

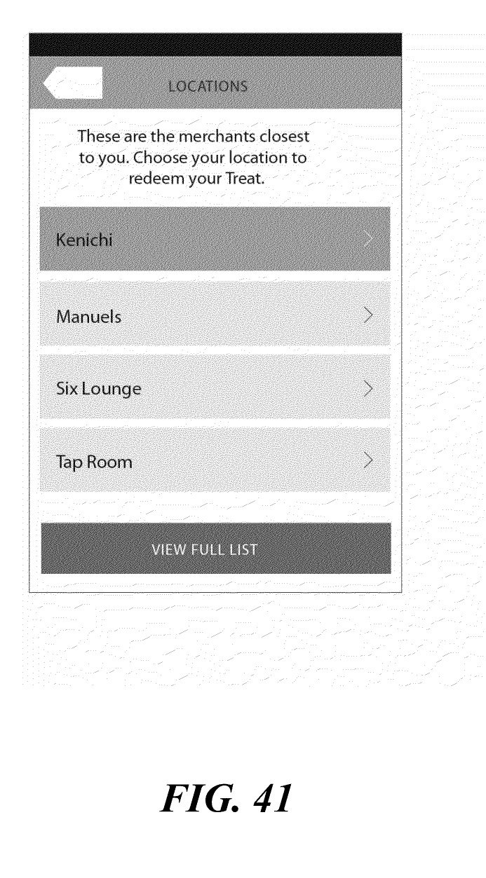

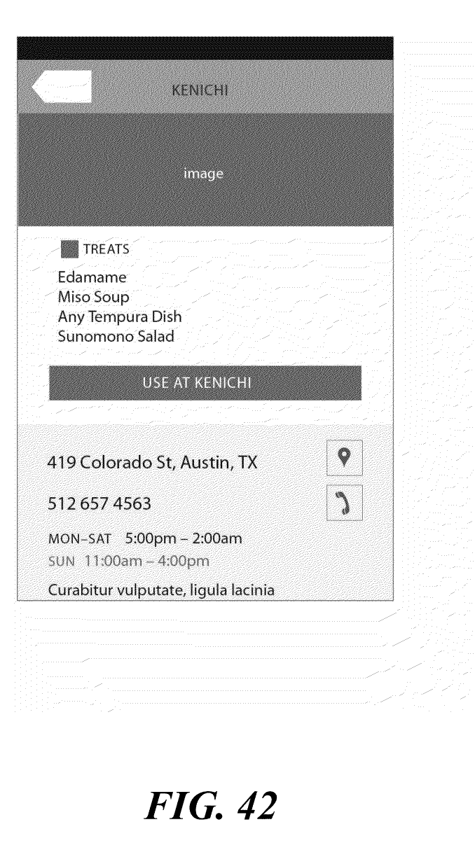

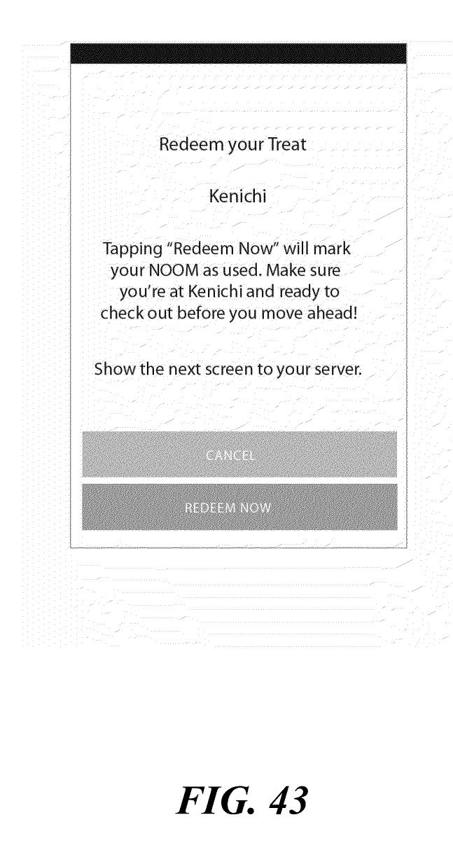

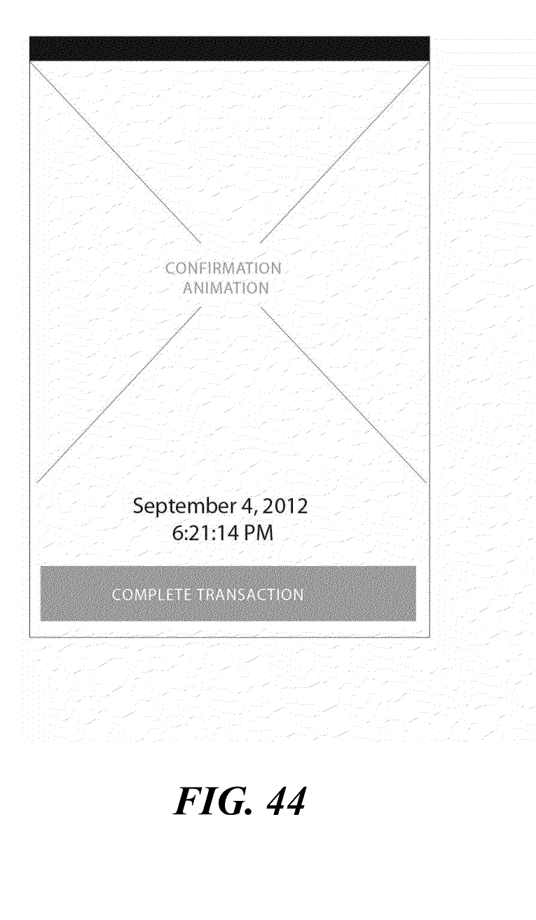

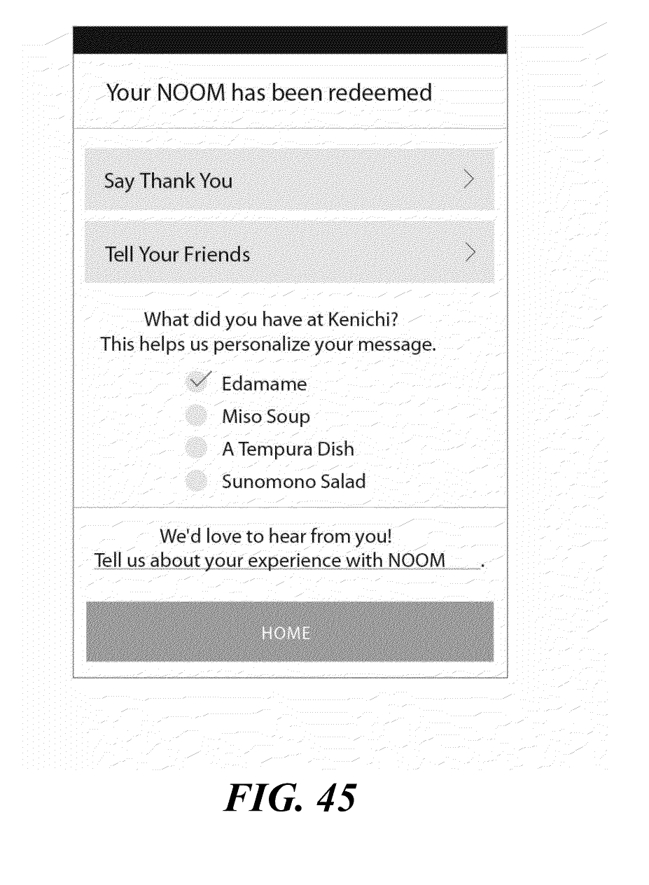

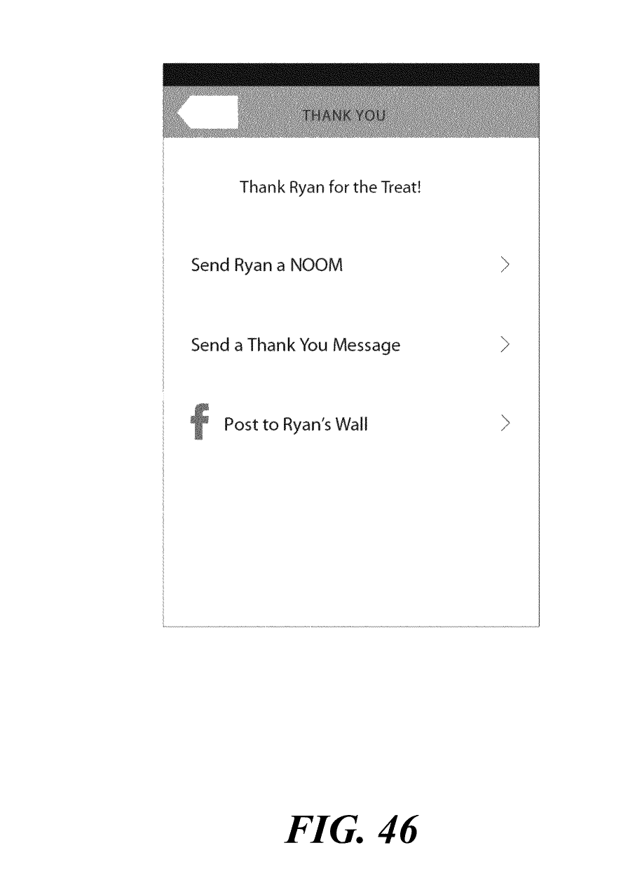

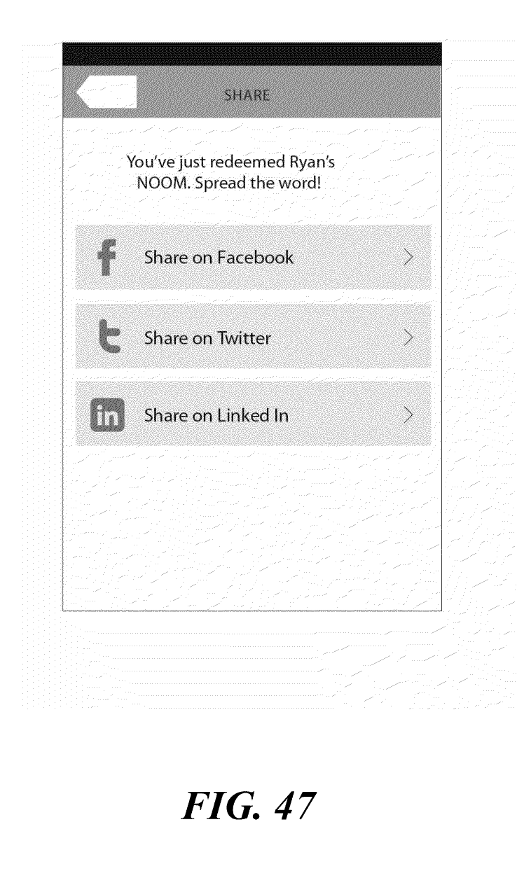

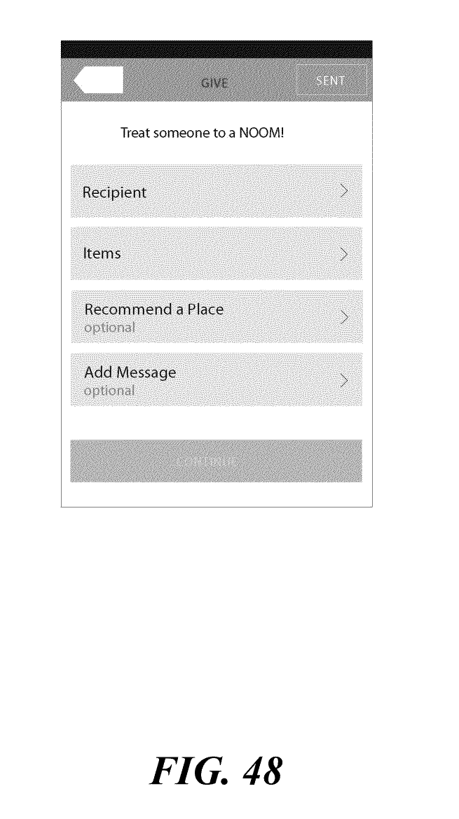

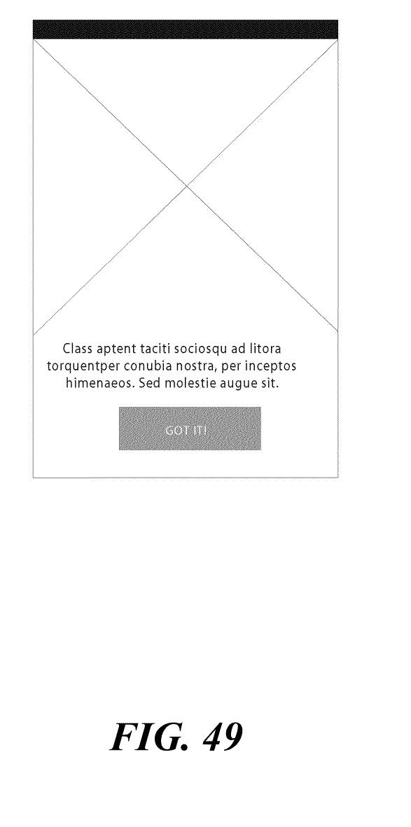

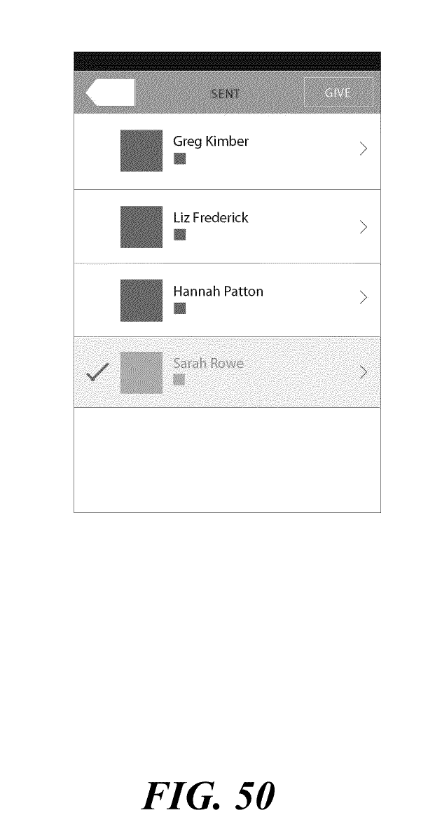

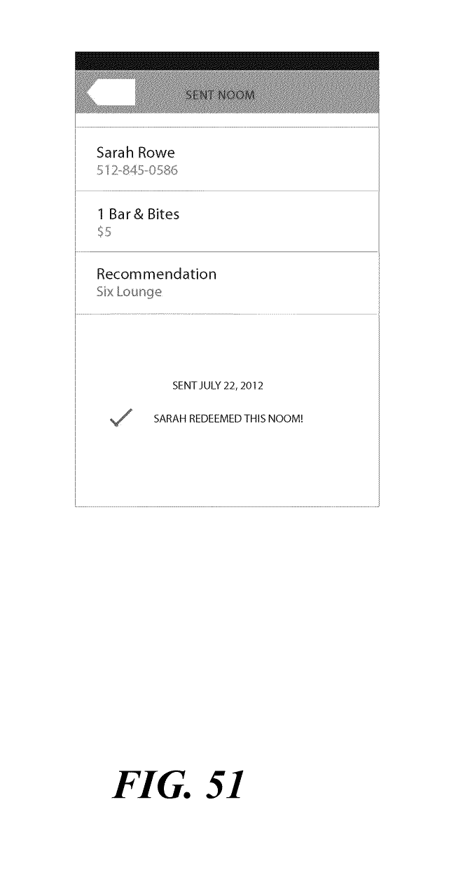

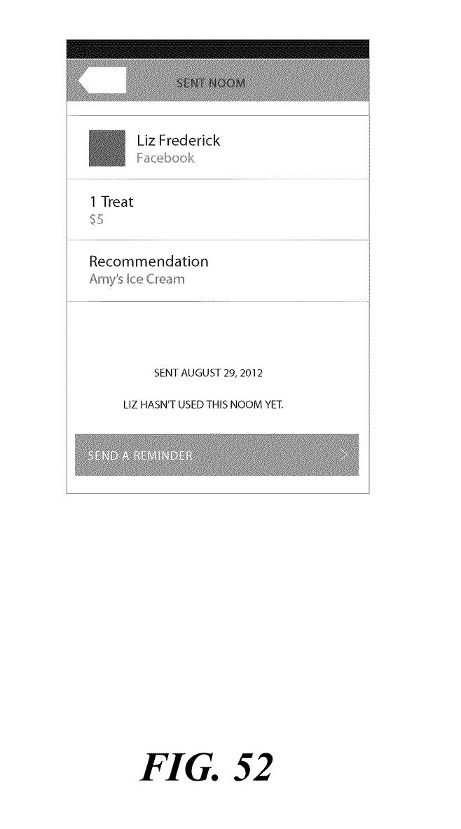

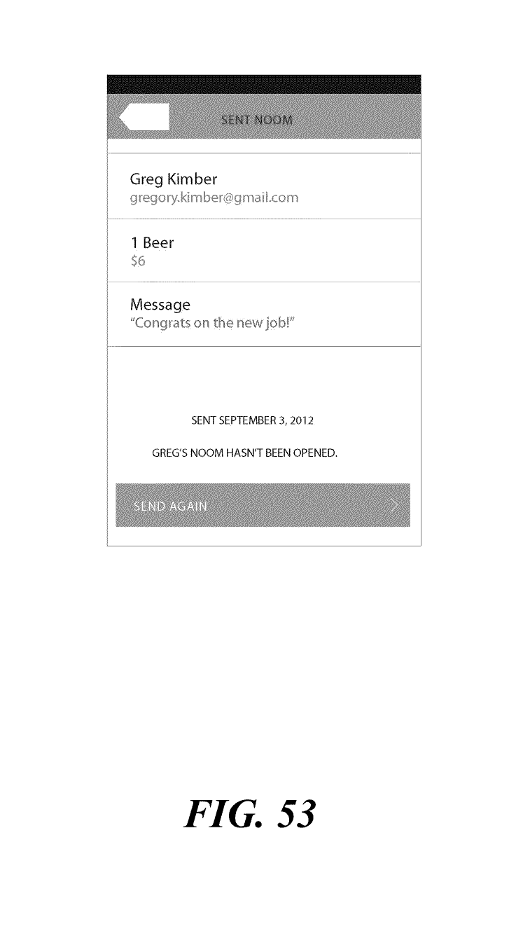

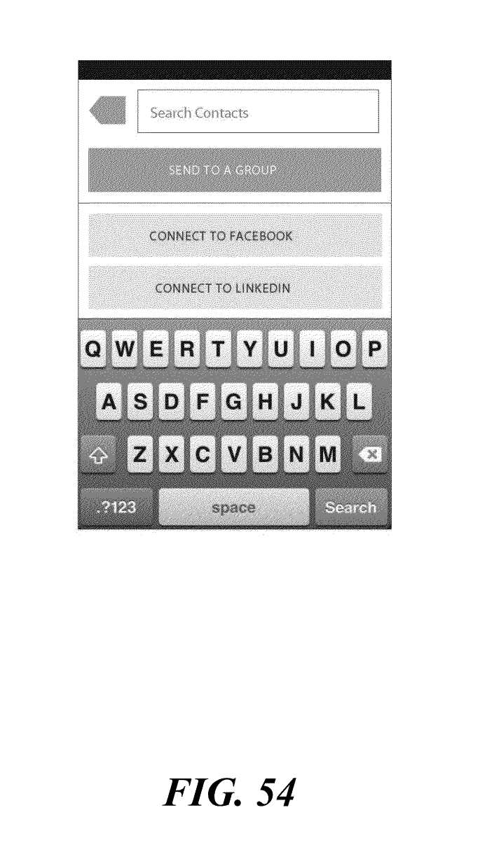

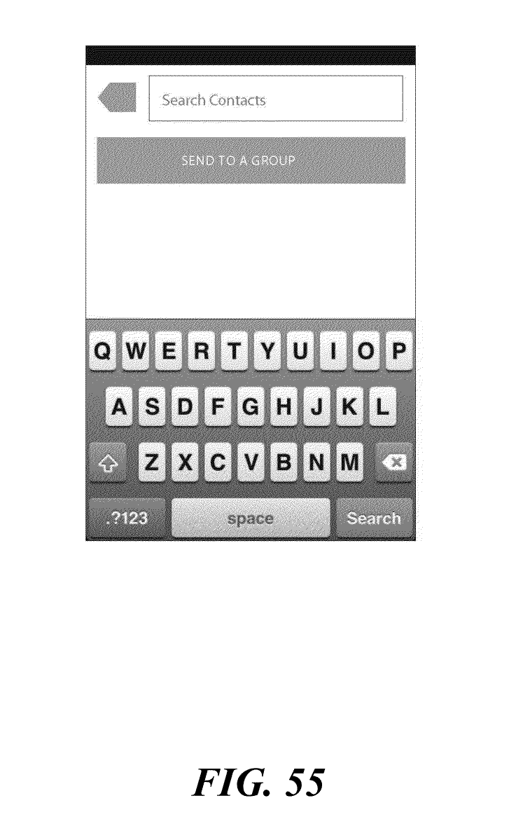

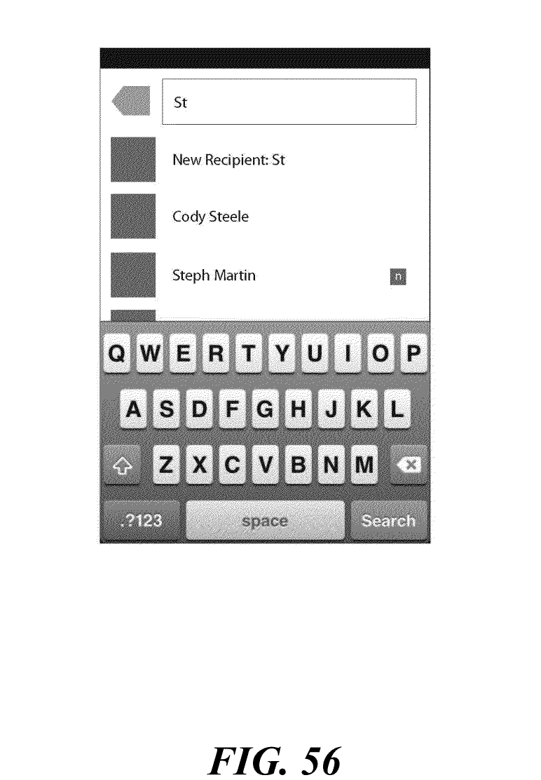

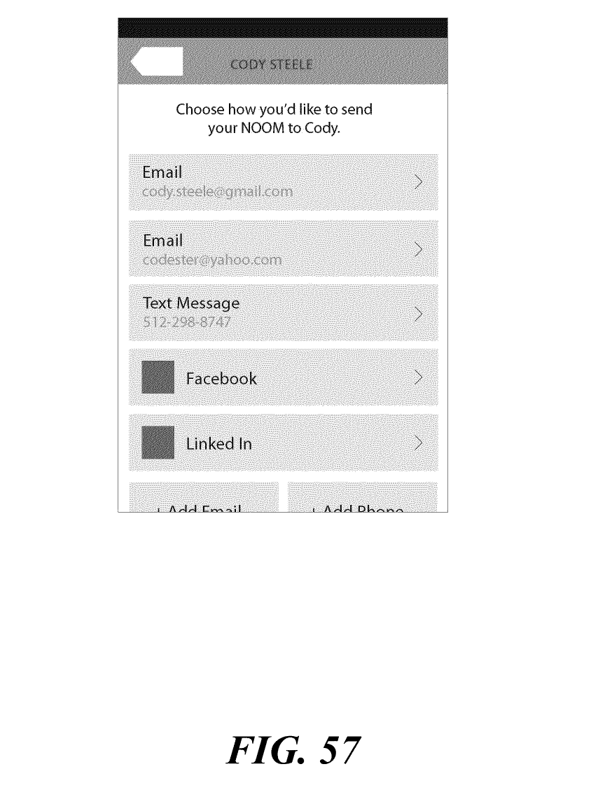

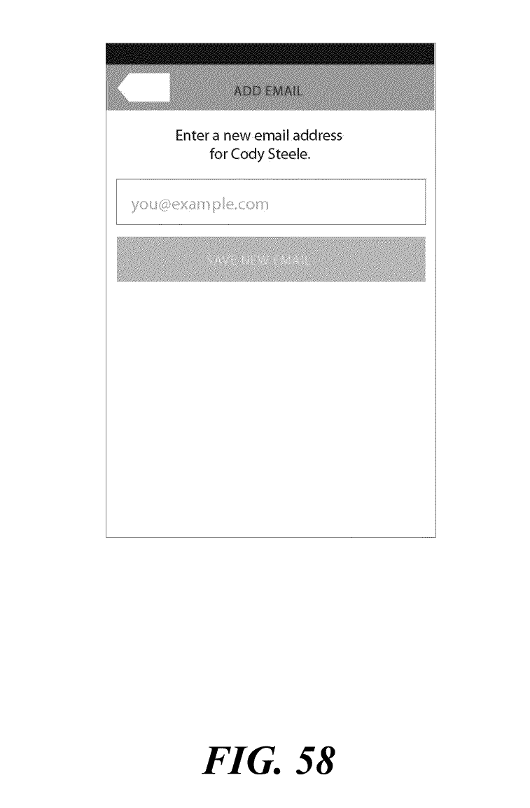

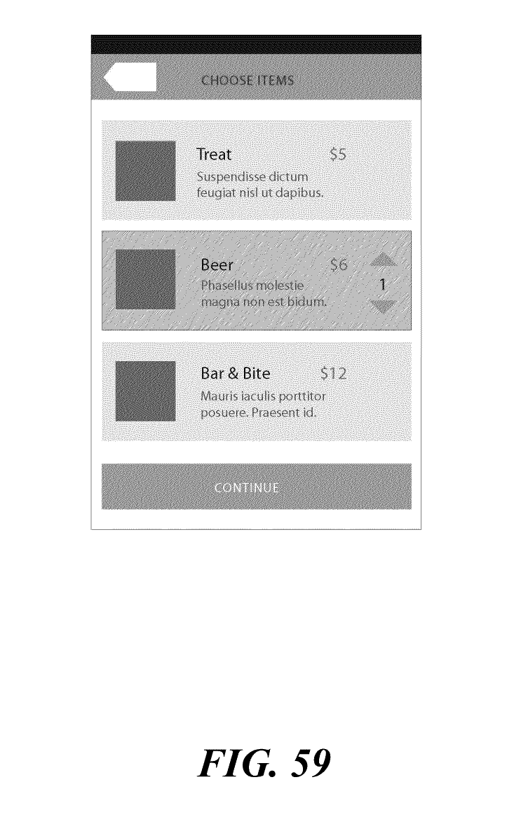

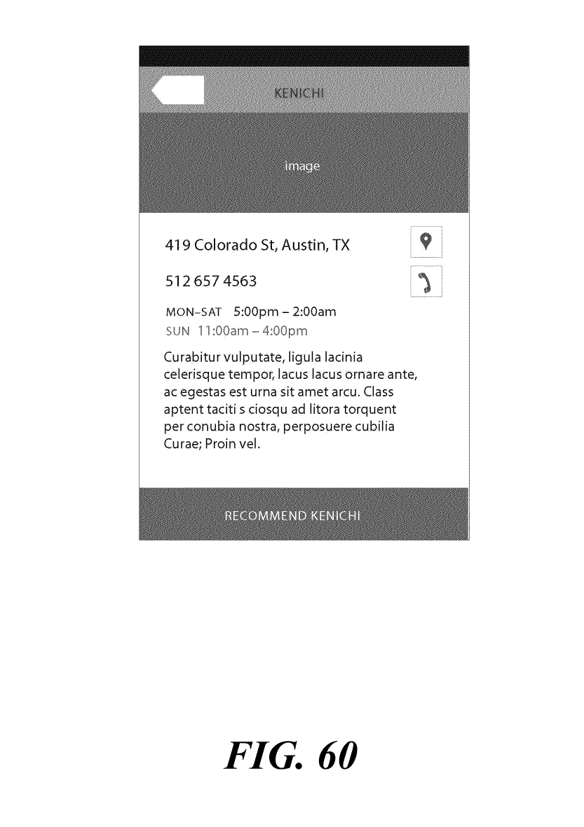

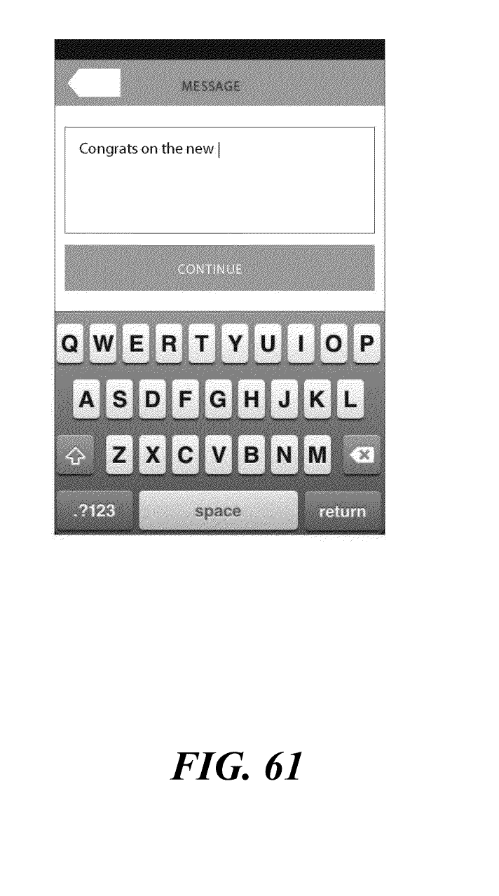

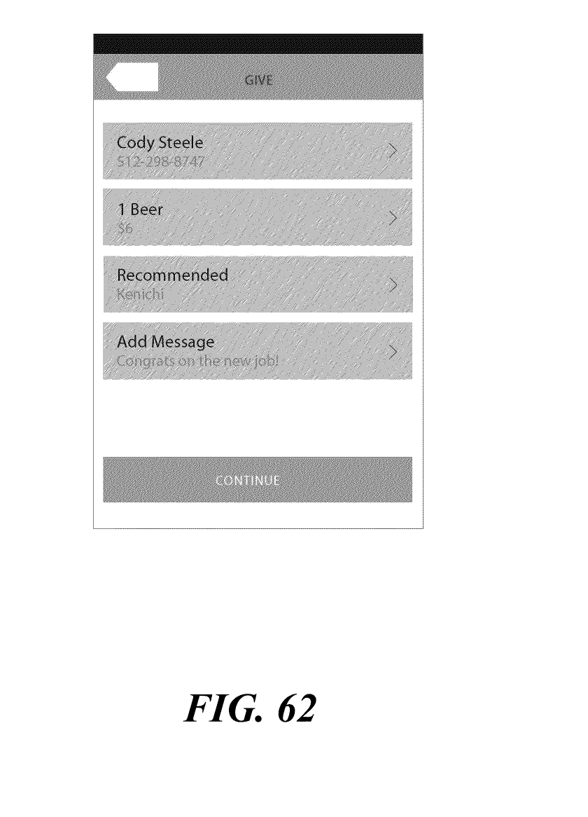

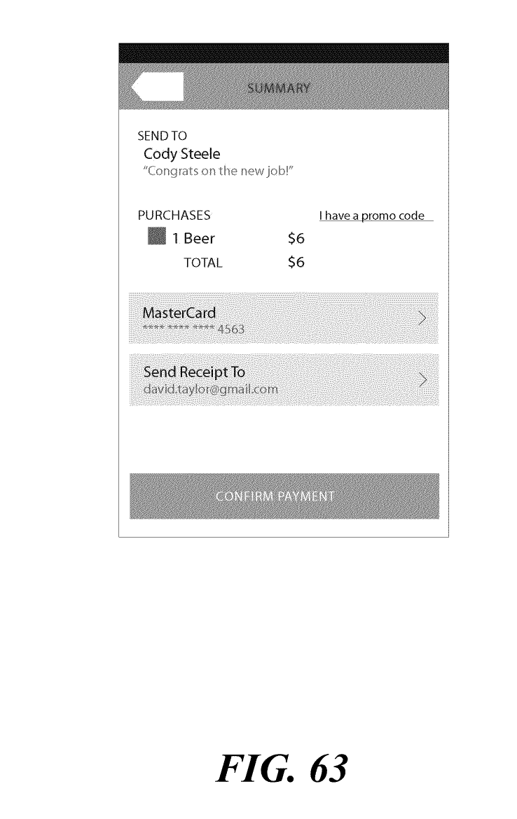

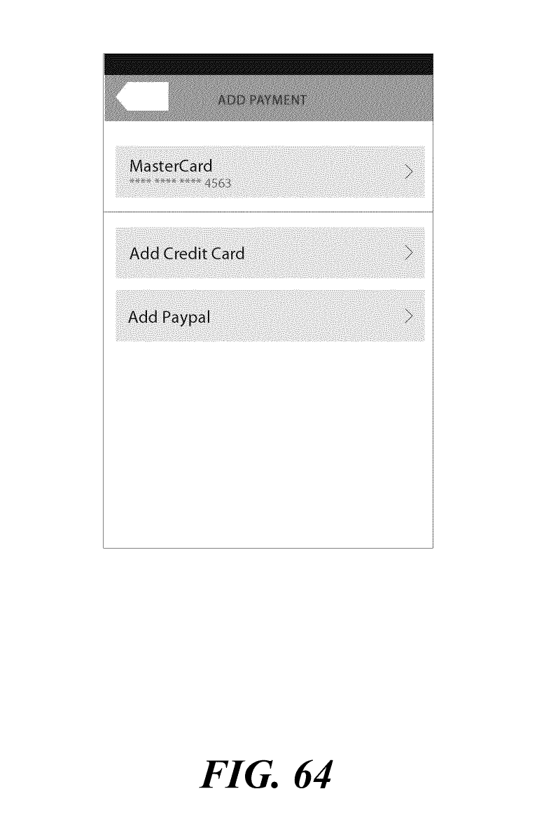

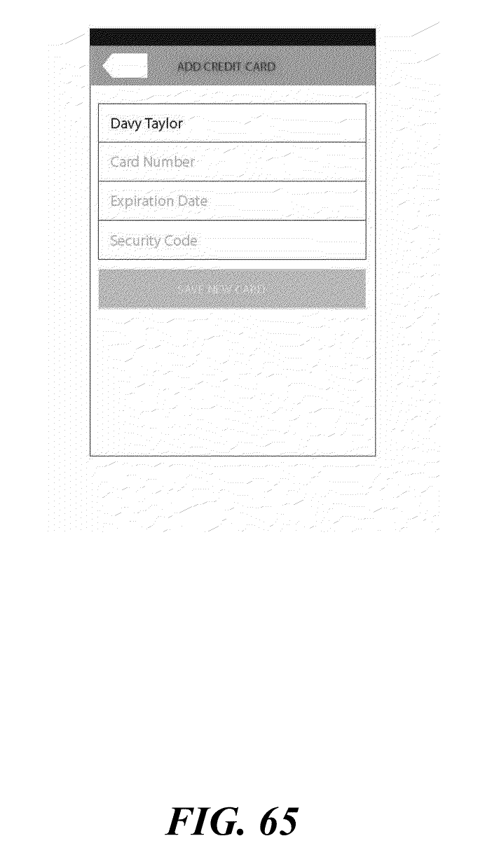

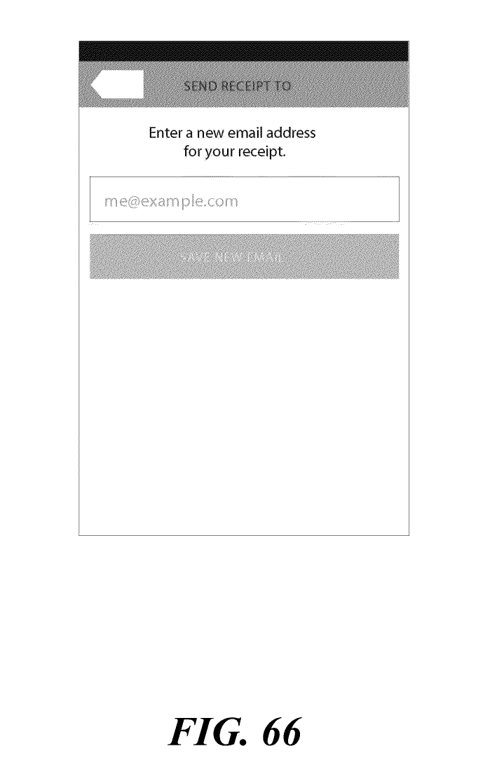

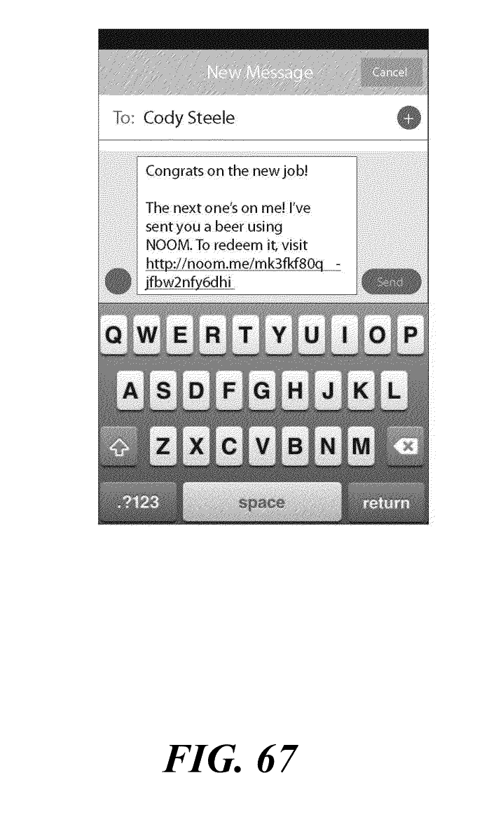

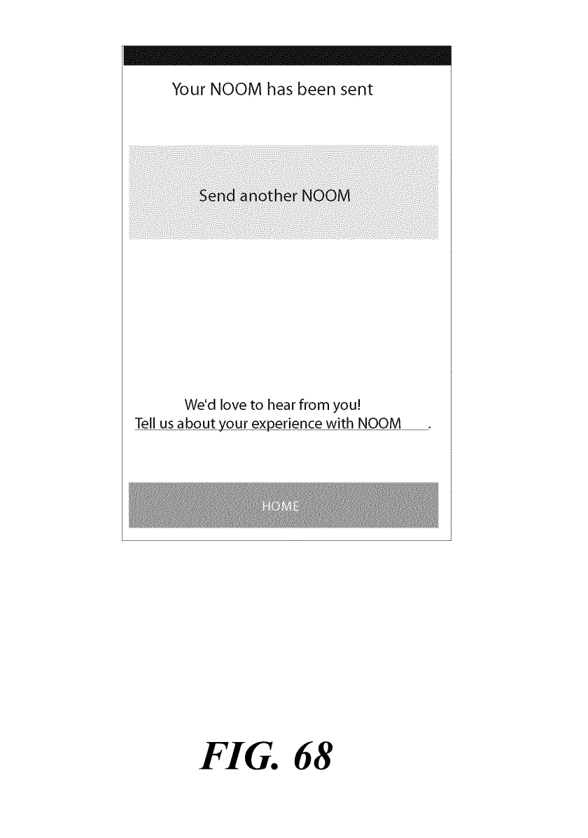

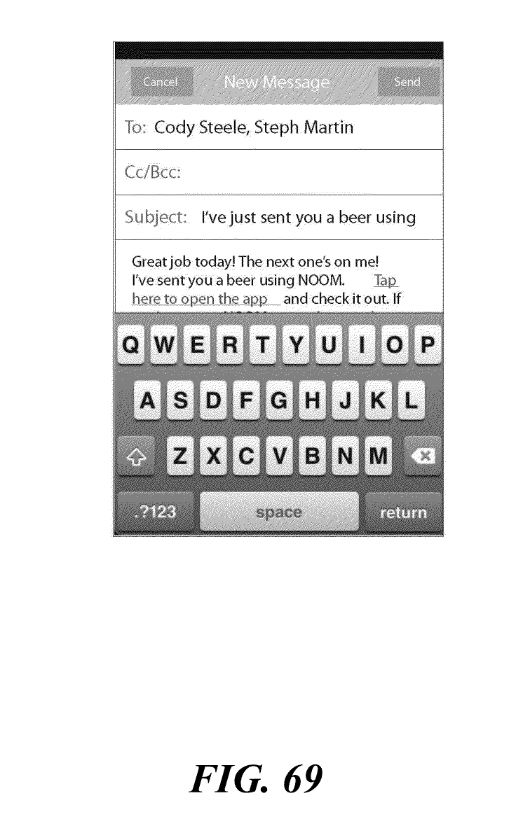

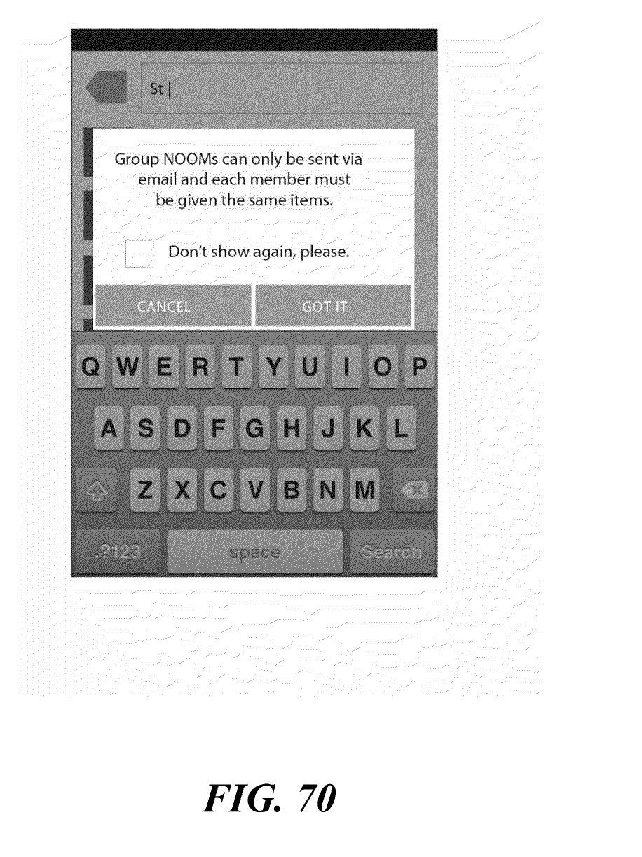

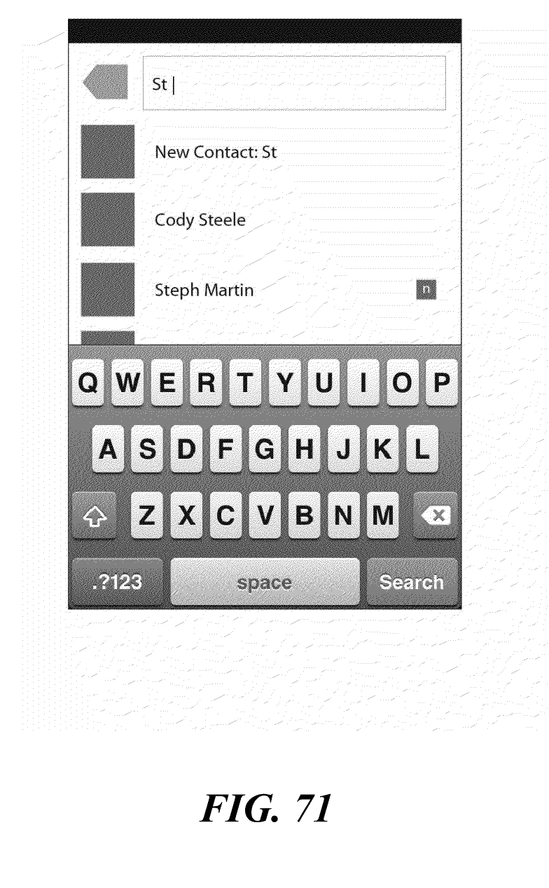

FIGS. 22-88 are wireframes showing the main display area of a first particular, non-limiting embodiment of a software system disclosed herein which implements a system and method for exchanging gifts (in the form of electronic gift tokens) in accordance with the teachings herein. Since the illustrations are merely wireframes, it will be appreciated that various embodiments of the systems and methodologies illustrated therein may have various arrangements, implementations and designs (both aesthetic and functional) of the objects and functionalities depicted. For this reason, the wireframes frequently utilize lorem ipsum as placeholder text, it being understood that actual embodiments of the software would use appropriate, meaningful text.

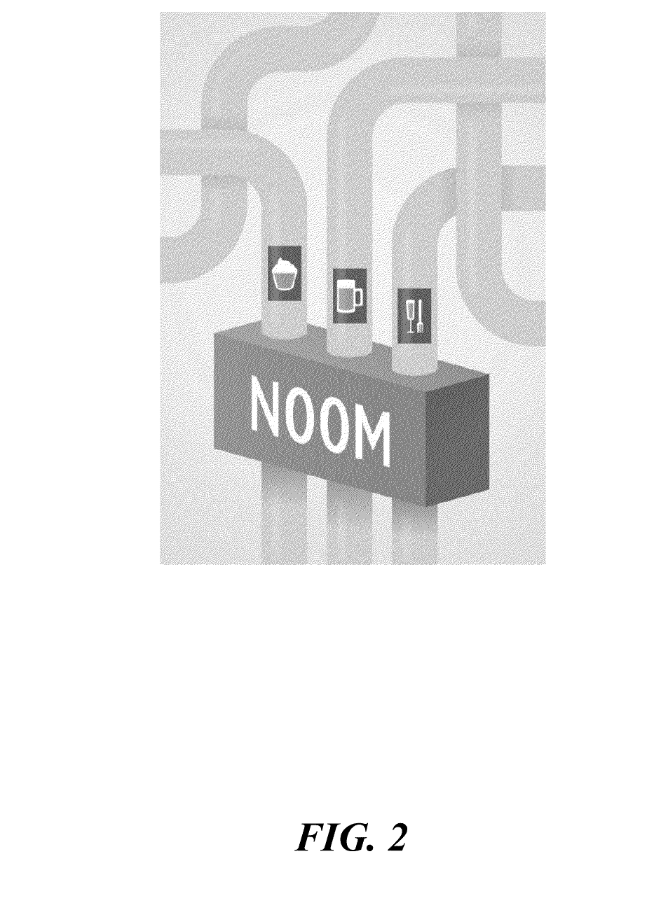

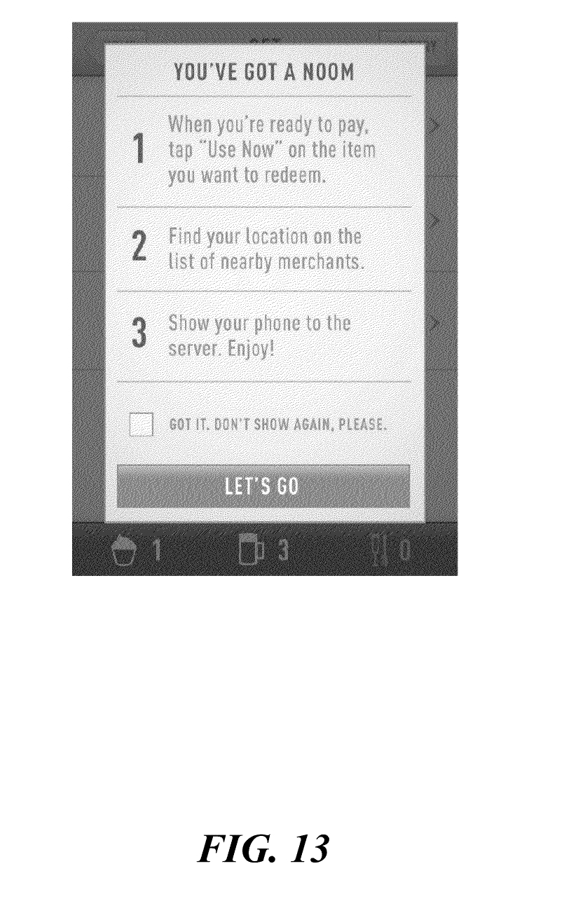

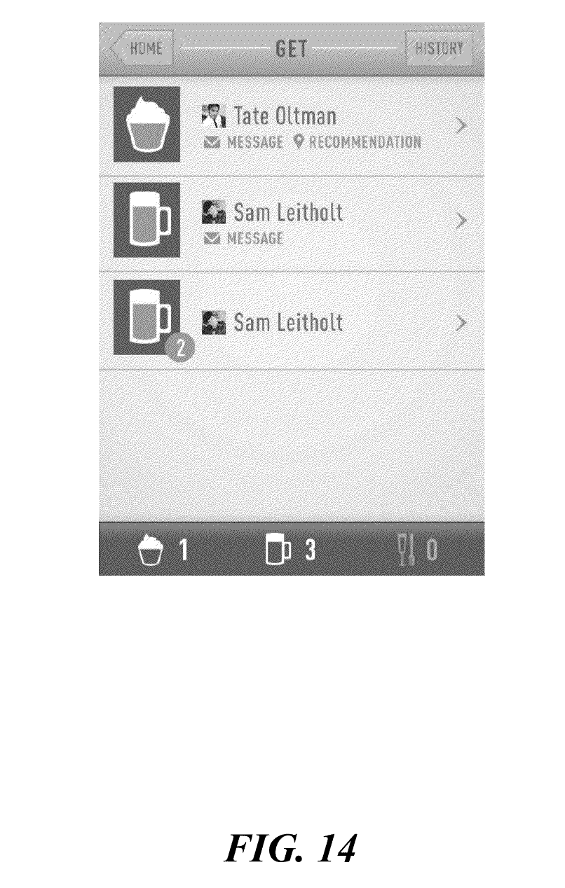

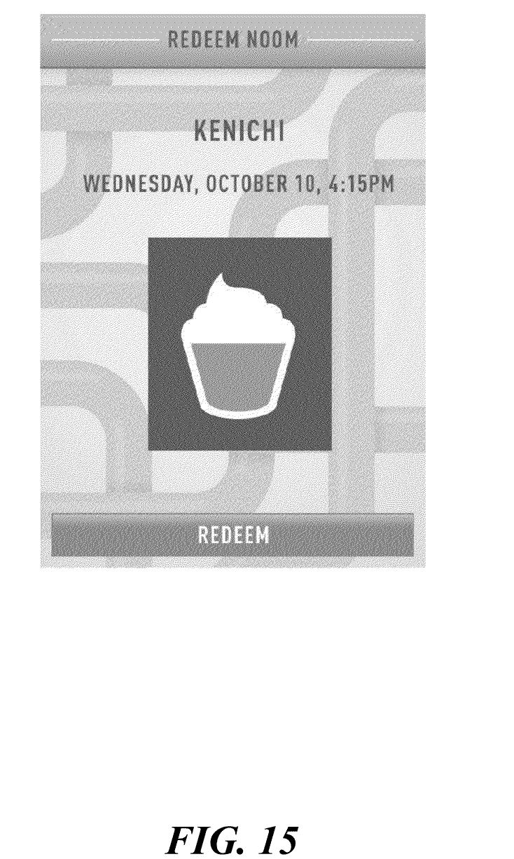

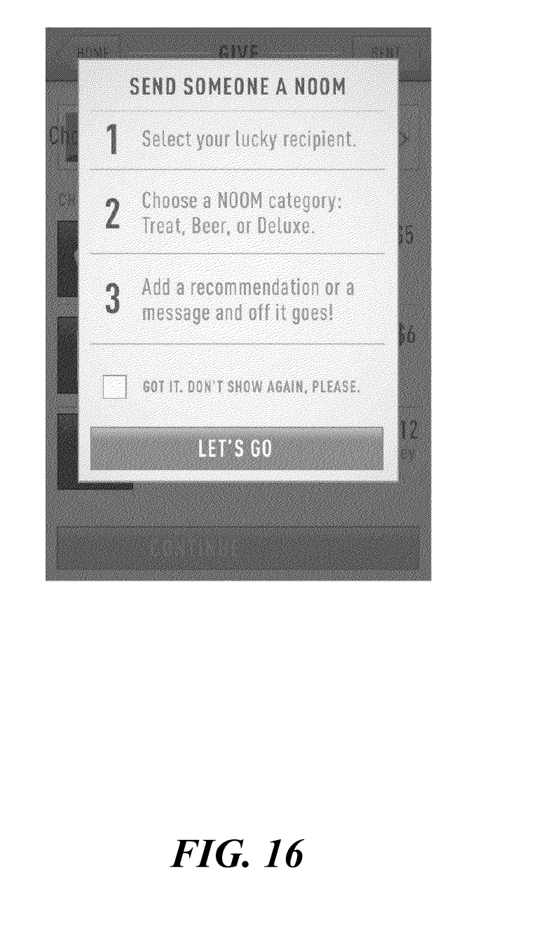

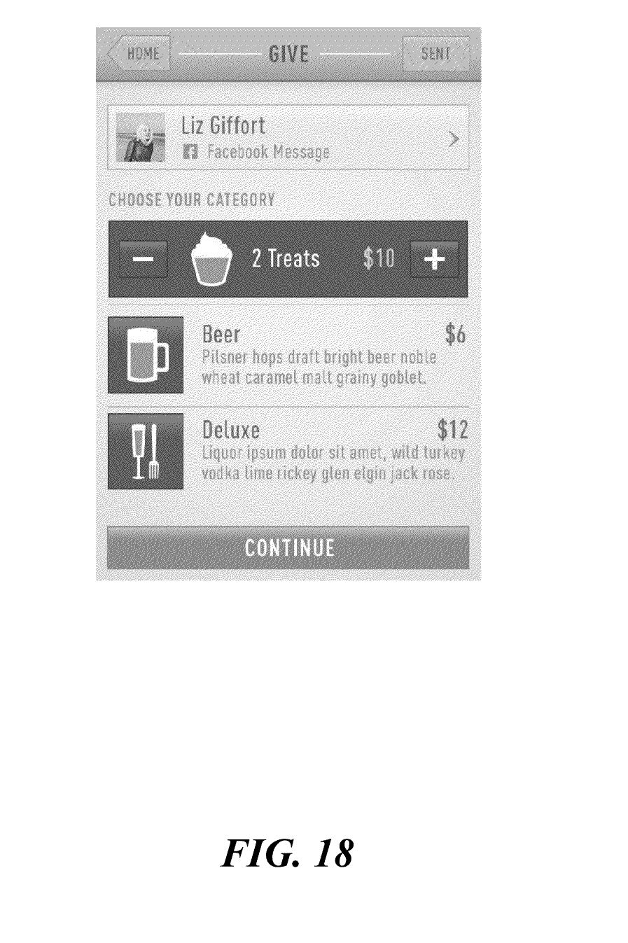

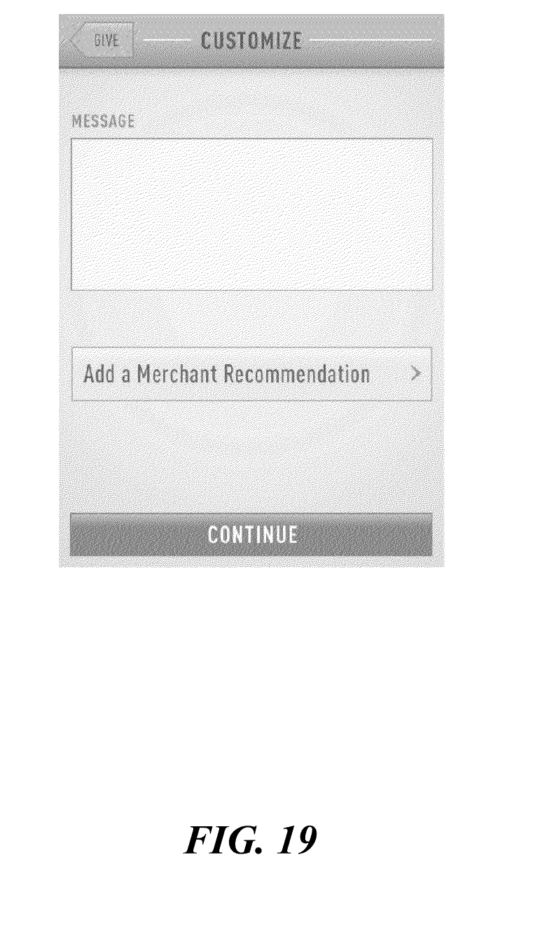

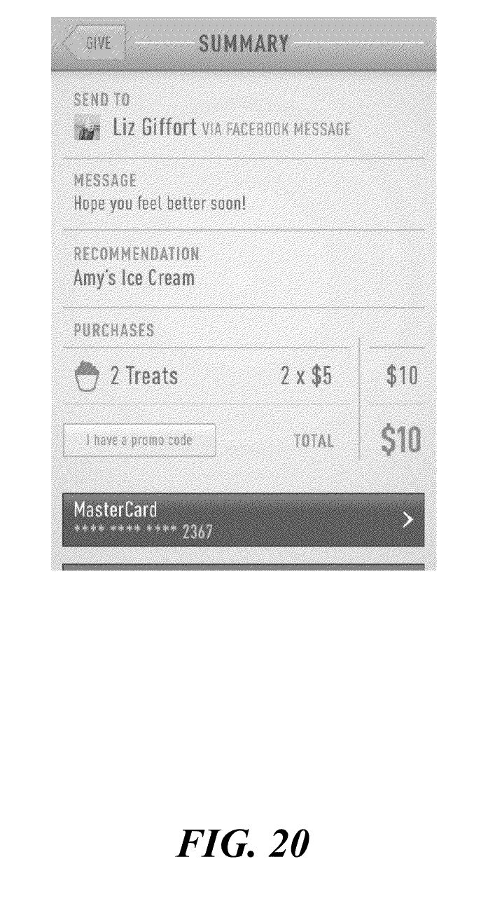

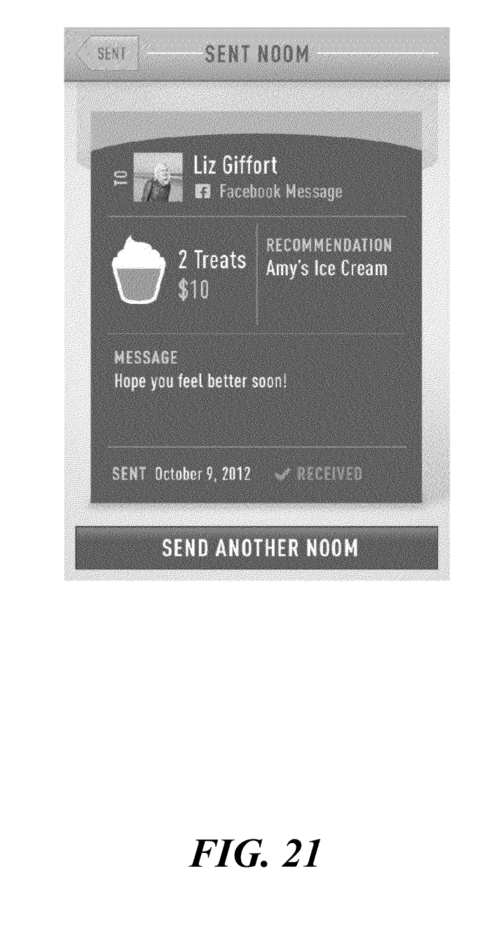

By way of illustration, FIGS. 2-21 show select screenshots from the main display area of a particular, non-limiting embodiment of a software system based on the FIGS. 22-88, and hence illustrate some of the aesthetic or ornamental features and dispositions of objects that are possible in such a software system. For ease of illustration, FIGS. 2-88 depict only screenshots from pages as they would be rendered by the software on the main display area of a mobile technology platform, and hence omit such features as the mobile technology platform itself and any toolbars or other areas reserved for the operating system or for other special functionalities.

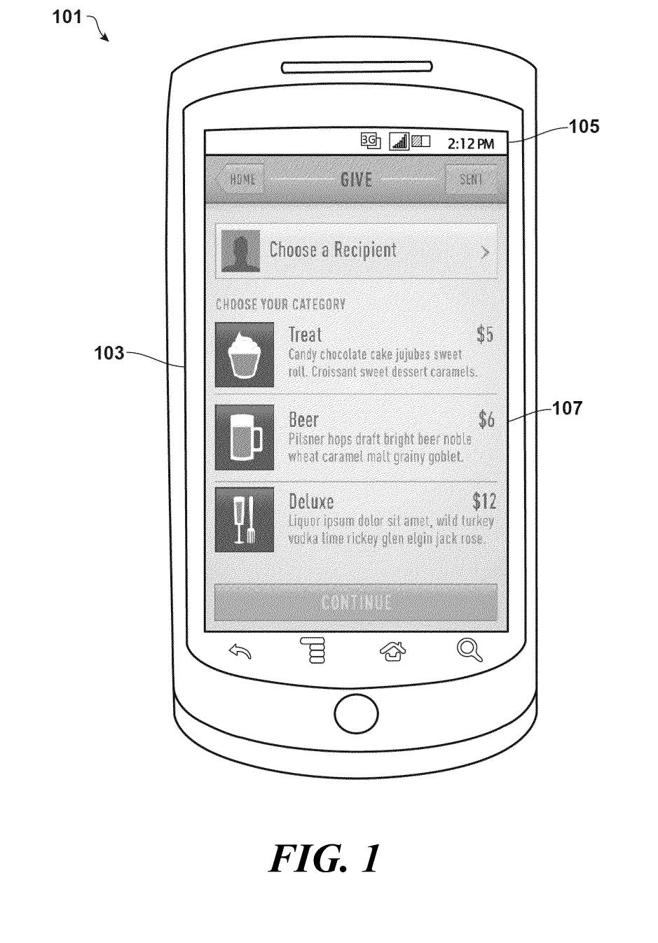

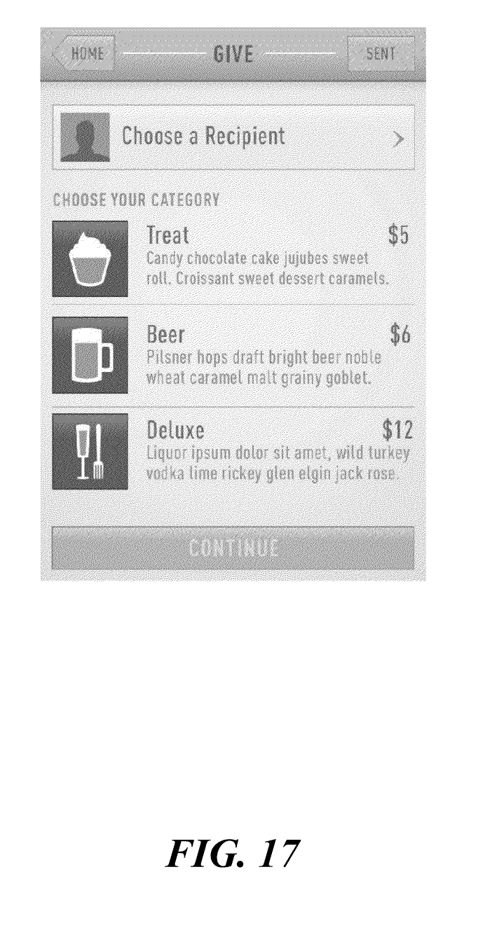

FIG. 1 is an illustration of a mobile technology platform equipped with the software of FIGS. 2-21, and showing the screenshot of FIG. 17. With reference thereto, a first particular, non-limiting embodiment of a system in accordance with the teachings herein is depicted as illustrated by its renderings on the display 103 of a mobile communications device 101. In particular, the operating system in the embodiment depicted has a toolbar 105 associated with it which is rendered at the top of the display 103 of the mobile technology platform 101. The operating system further has a main display area 107 associated with it upon which the pages of a software program (such as the pages depicted in the screenshots of FIGS. 2-88) are depicted. Of course, it will be appreciated that the systems and methodologies (and associated software) are not limited to their use on the particular device depicted, but may be used with a variety of technology platforms. These include, without limitation, smartphones, tablet PCs, laptop PCs, and desktop PCs.

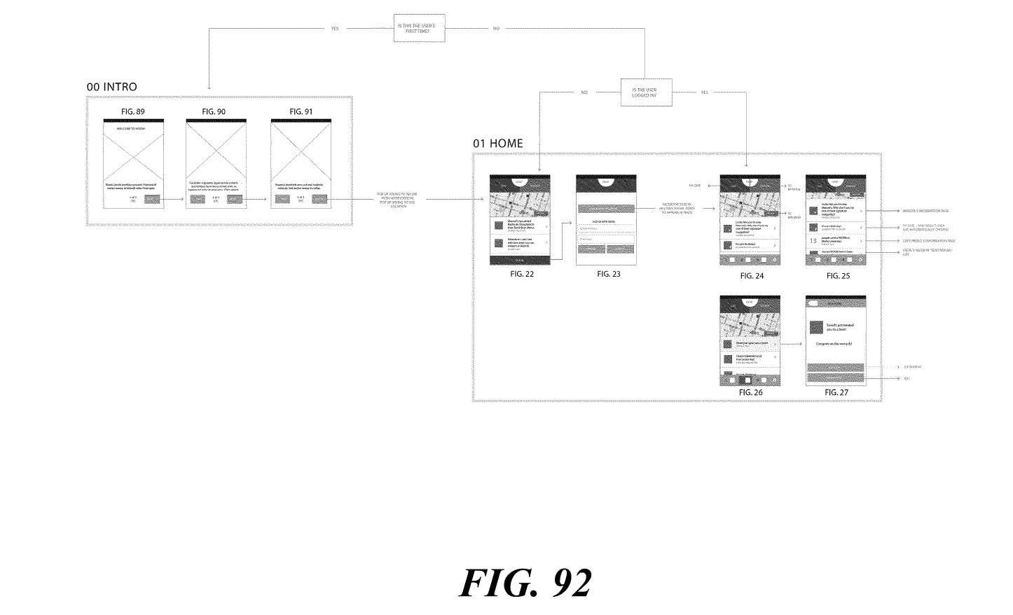

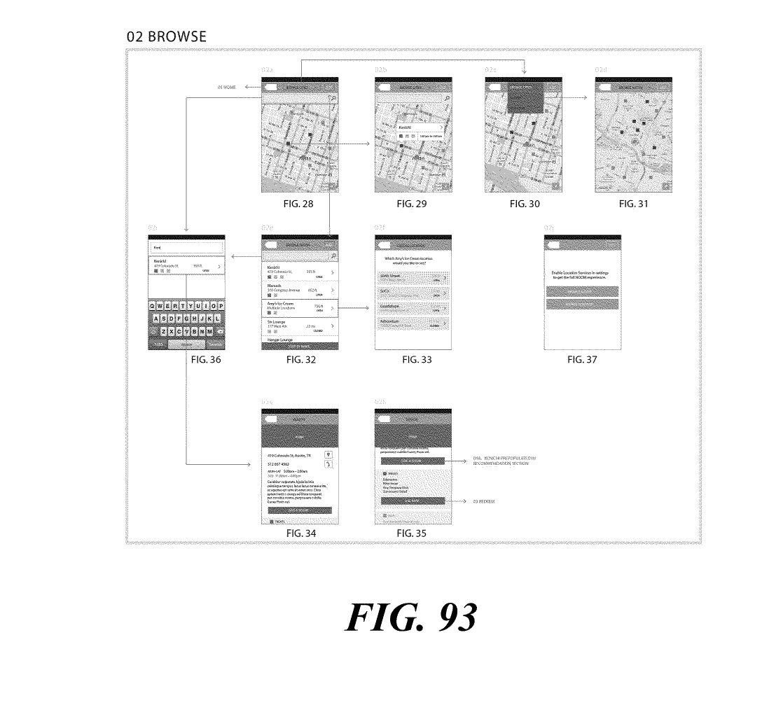

FIGS. 89-94 illustrate the operation of the software depicted in FIGS. 2-88. The software has seven main subroutines or components, each of which has various pages associated with it. These components include an introduction subroutine 201, a home subroutine 301, a browsing subroutine 401, a token redemption subroutine 501, a token gifting subroutine 601, a group token gifting subroutine 701, and a settings subroutine 801. Each of these is described in greater detail below.

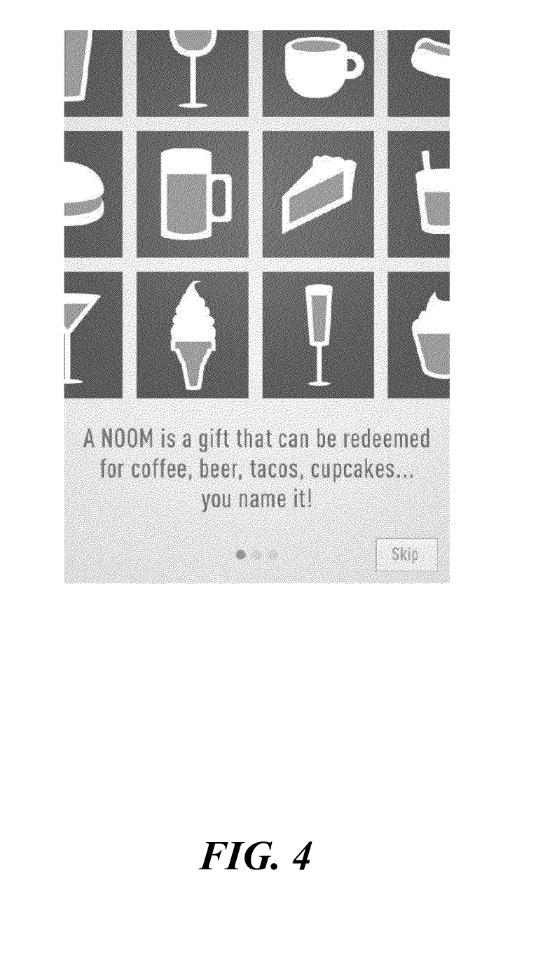

With respect to FIG. 89, the introduction subroutine 201 is triggered at application launch when a Boolean variable 203 representing whether the user is using the software for the first time has the value “true”. If so, a series of introductory pages 251, 253 and 255 such as those depicted, respectively, in FIGS. 89-91 (or corresponding pages 257, 259 and 261 depicted, respectively, in FIGS. 4-6) is rendered in succession on the user's display.

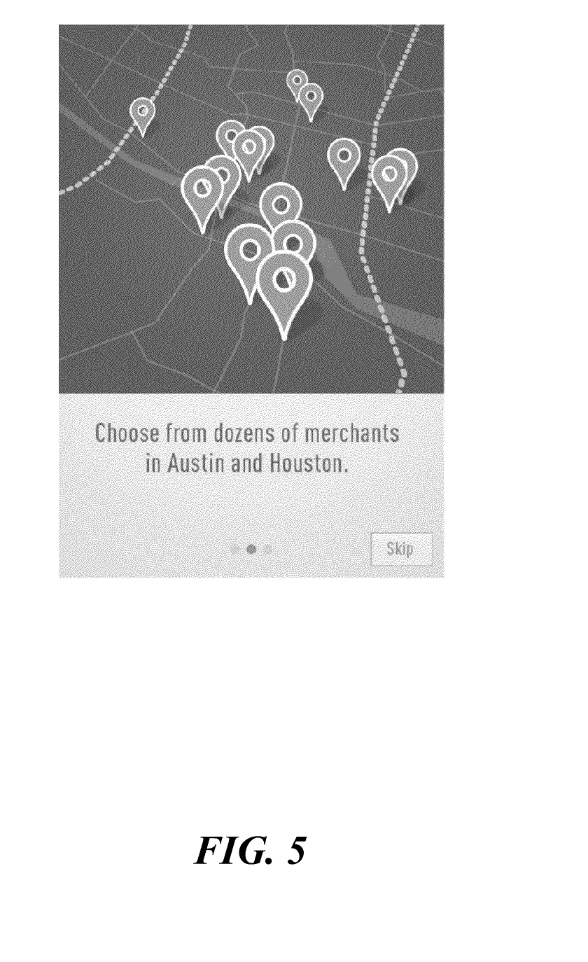

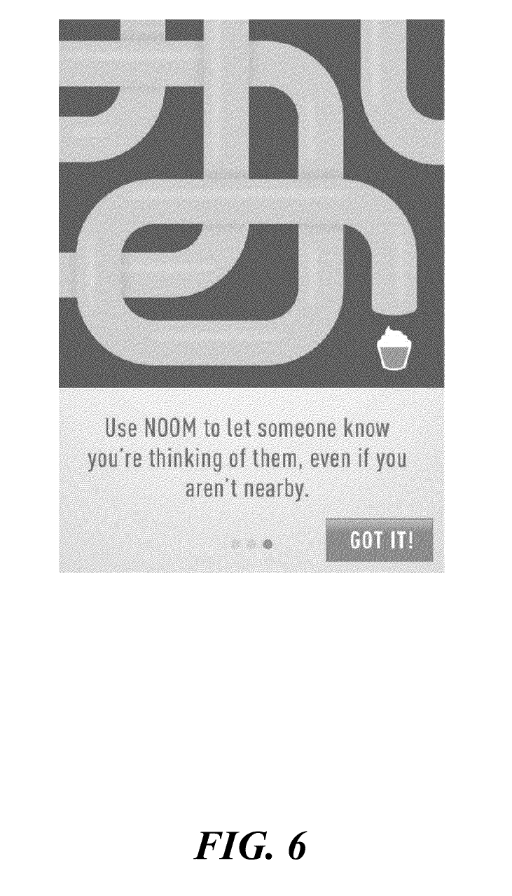

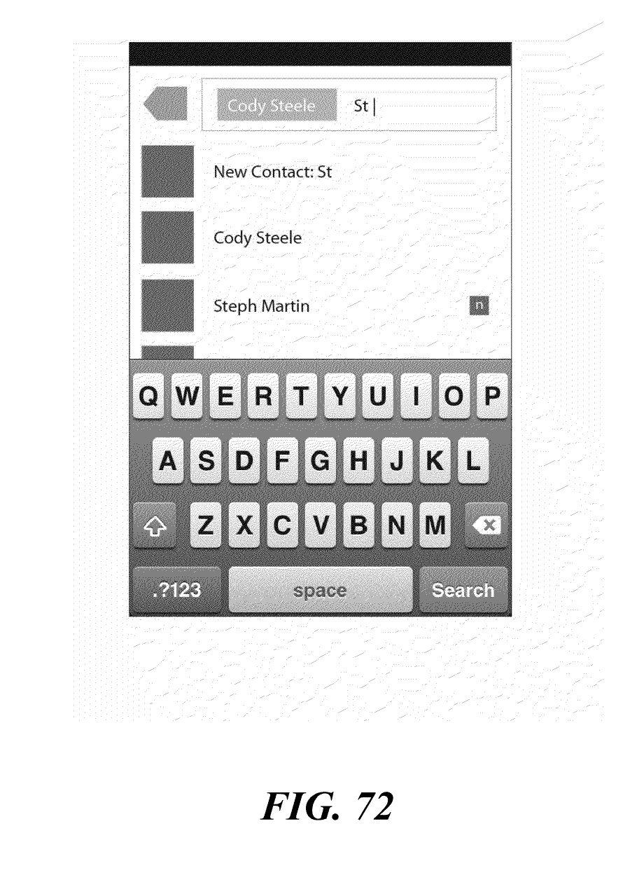

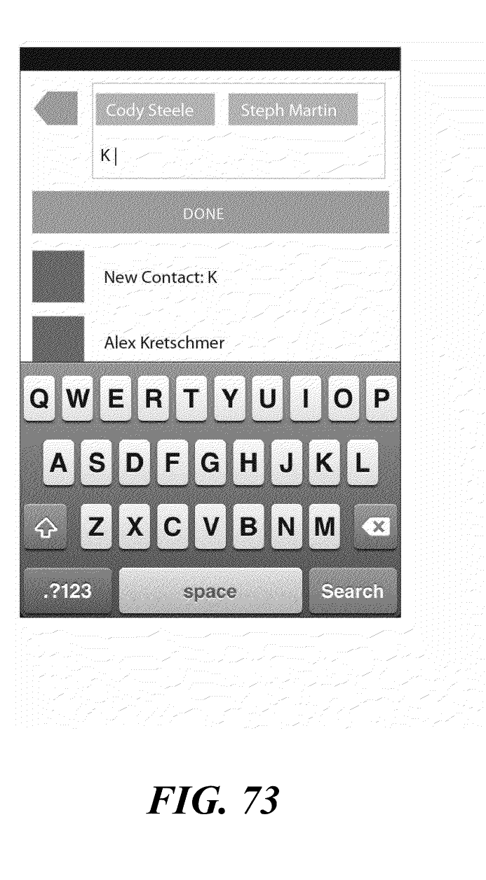

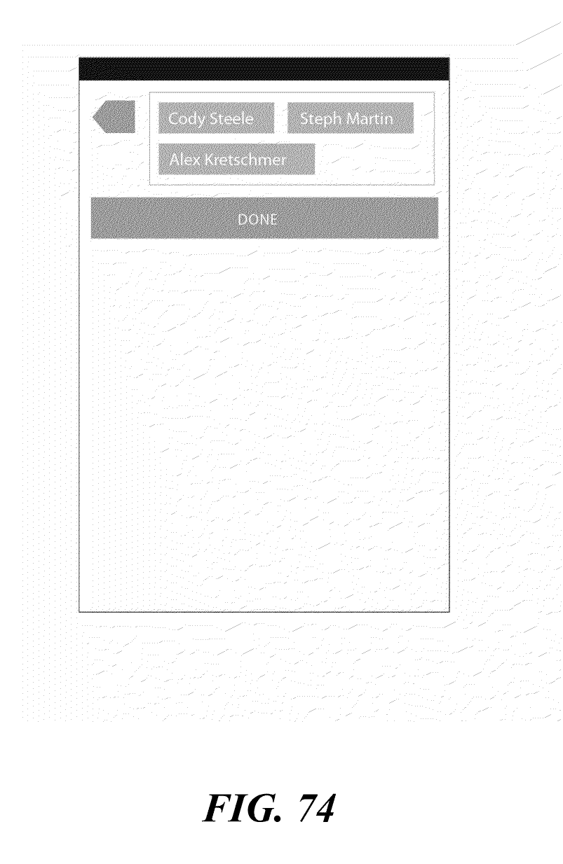

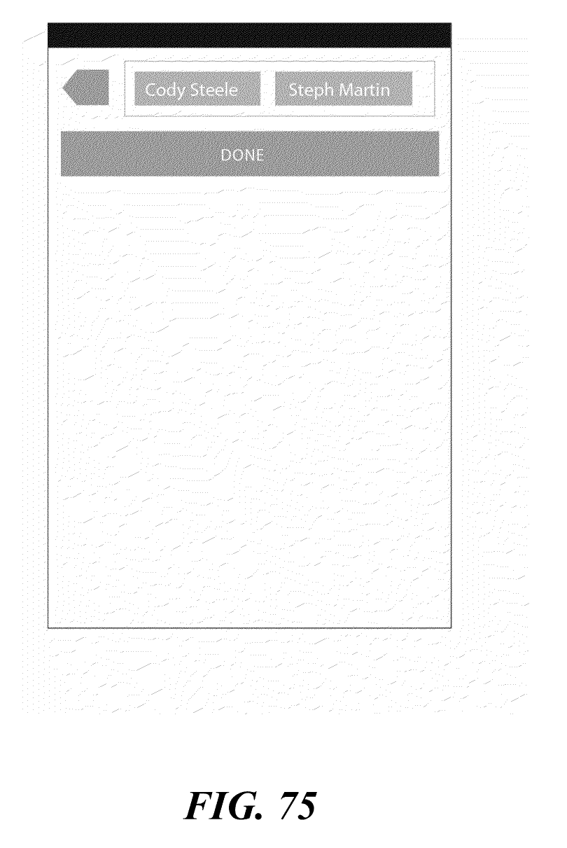

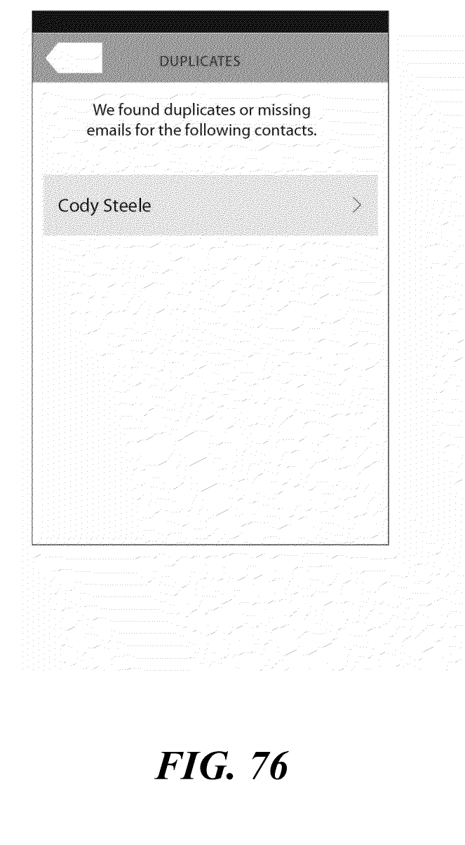

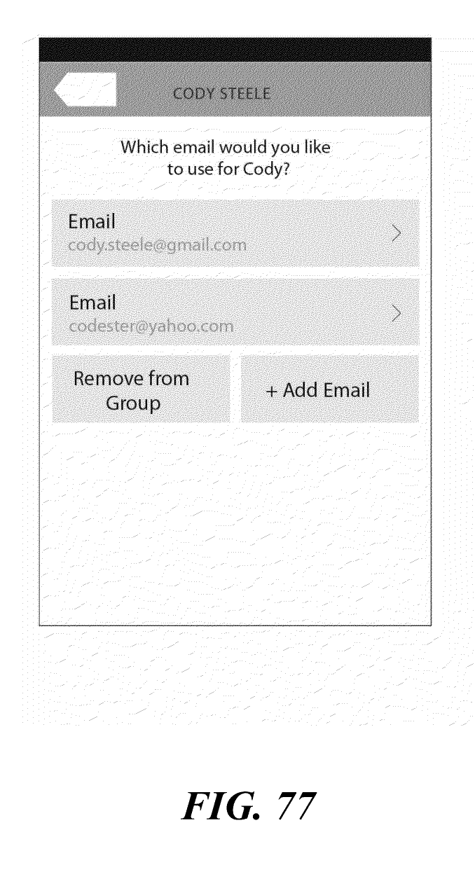

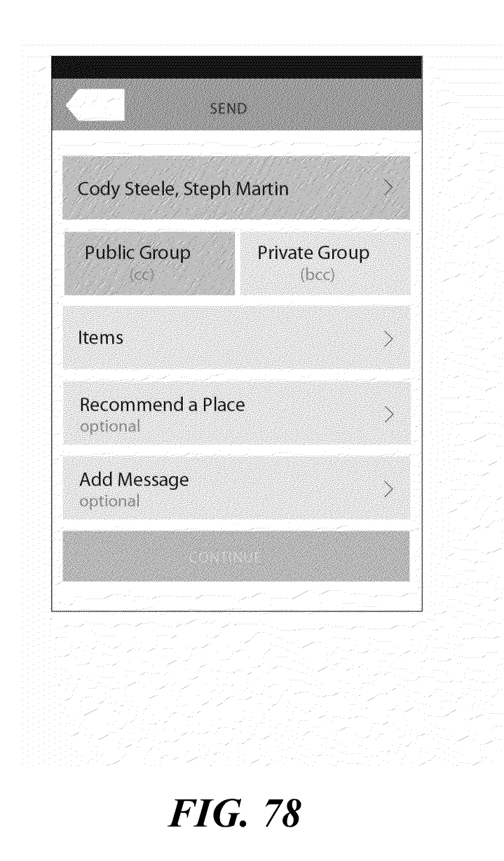

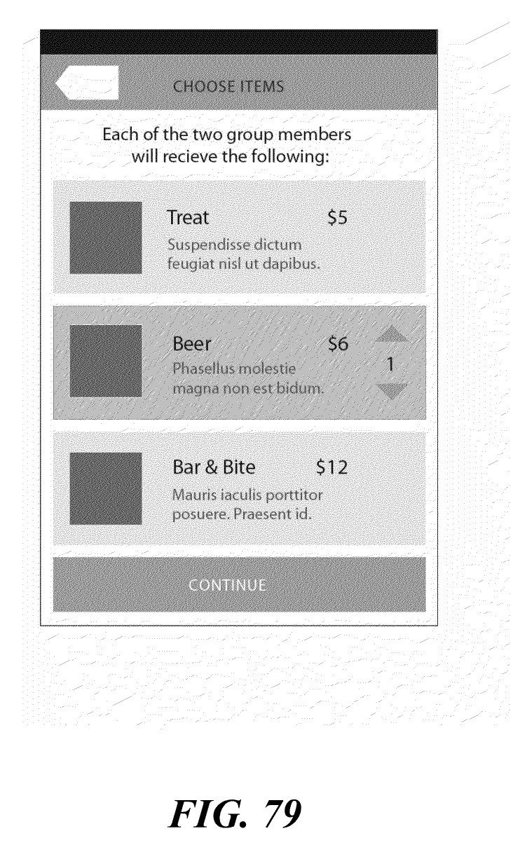

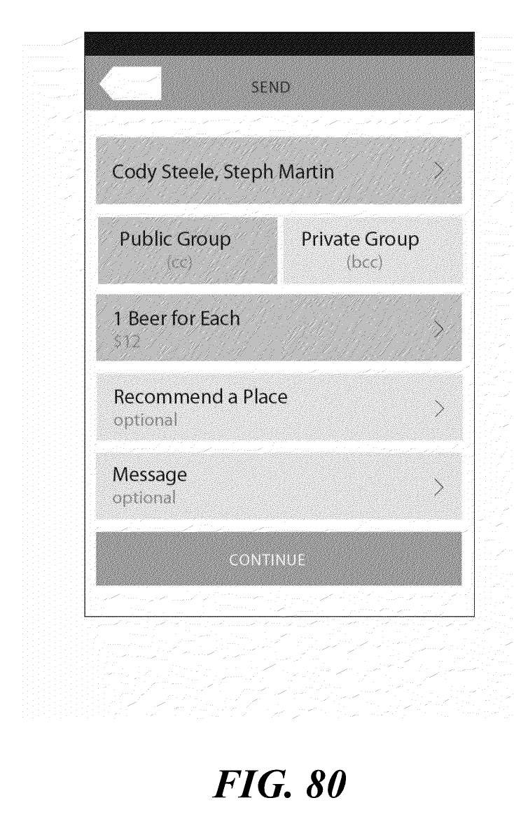

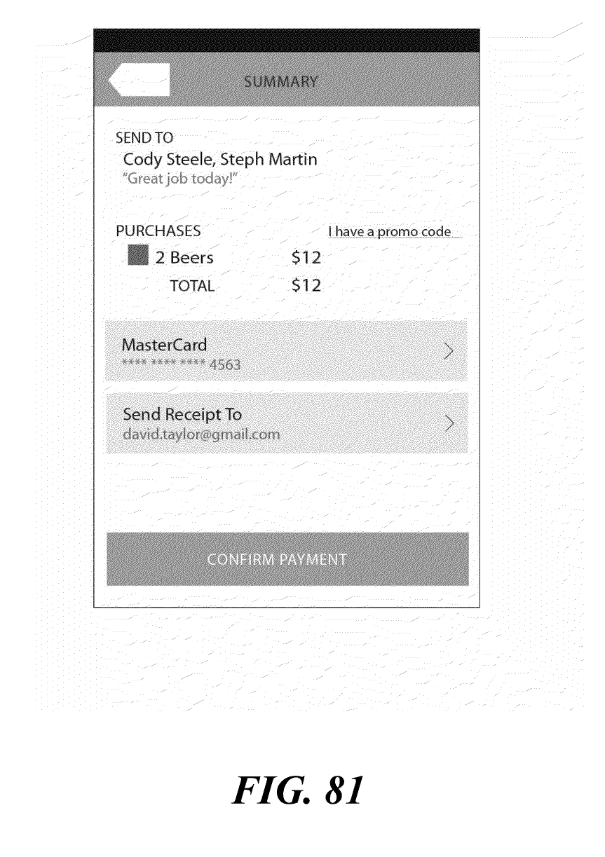

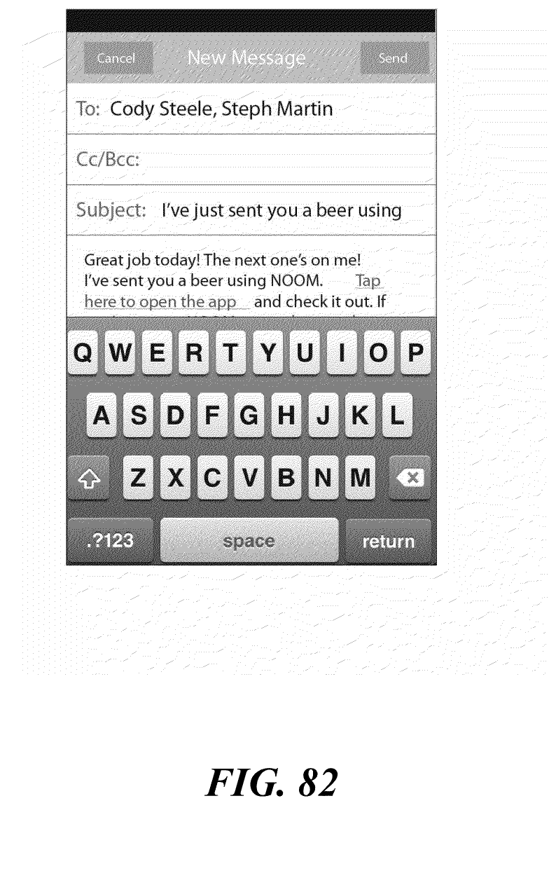

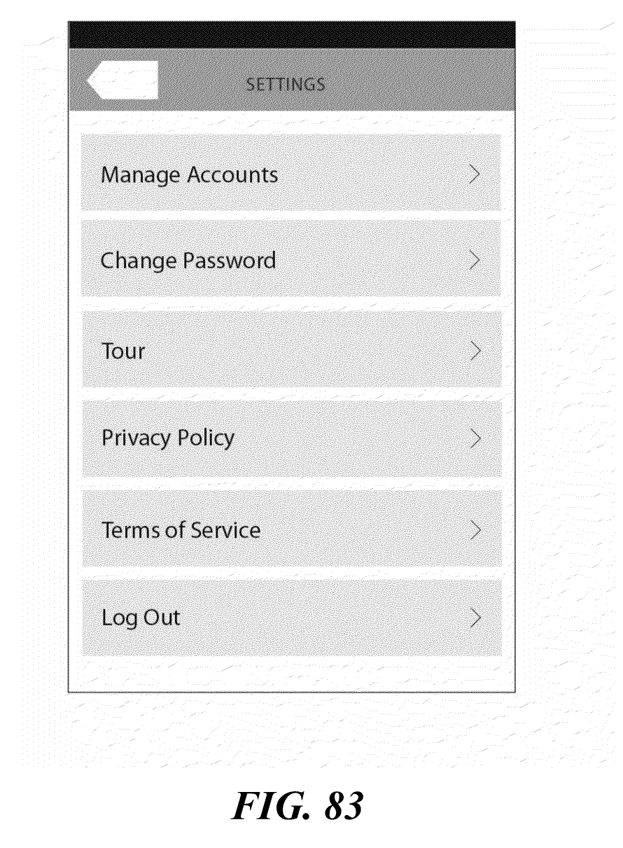

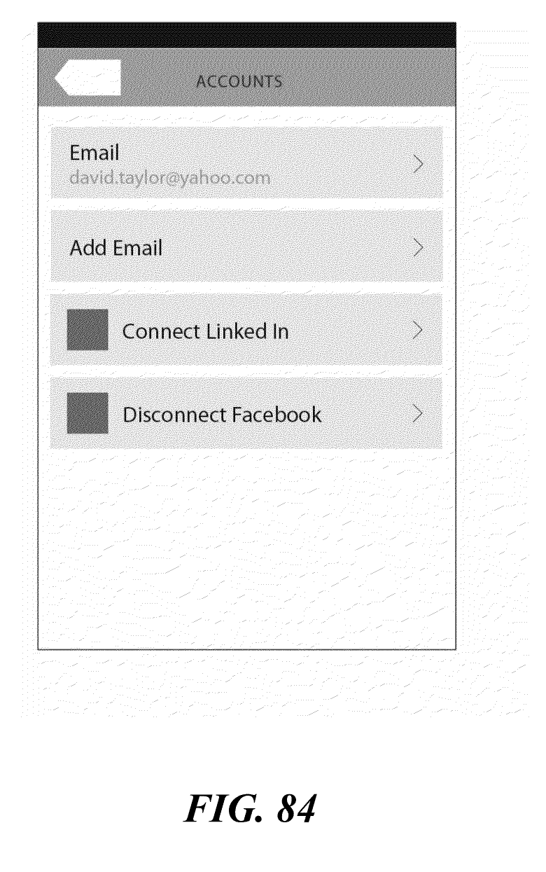

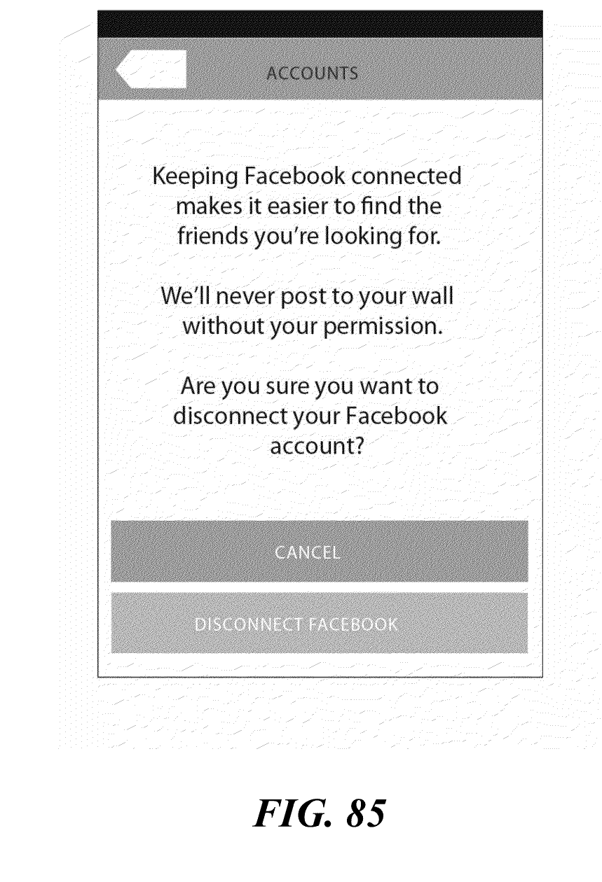

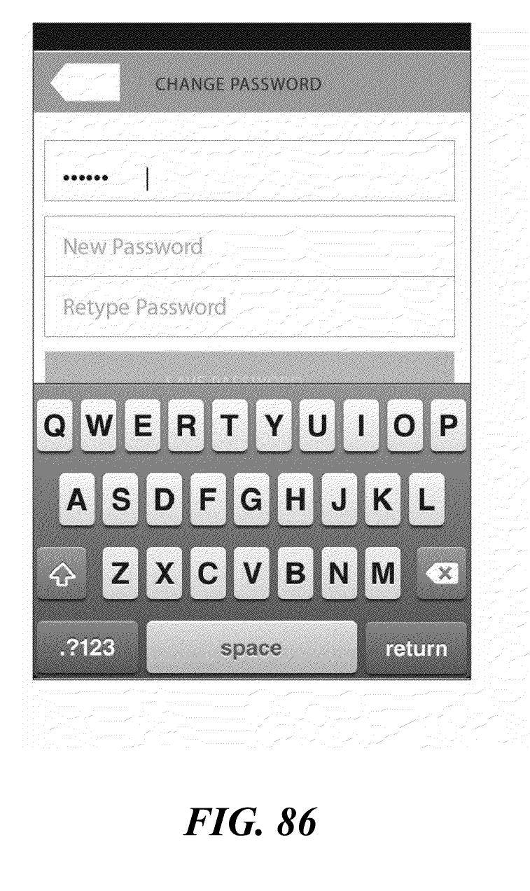

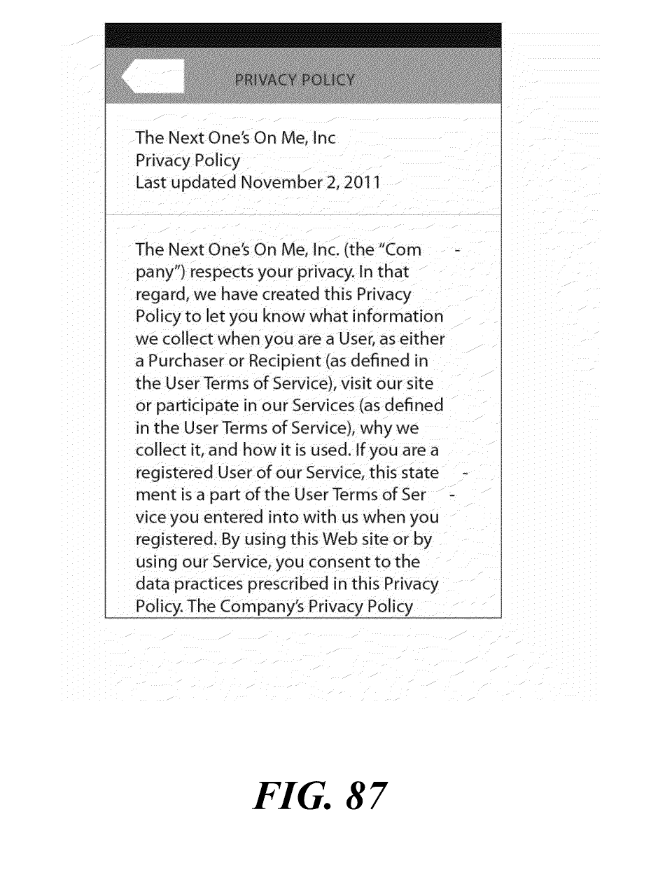

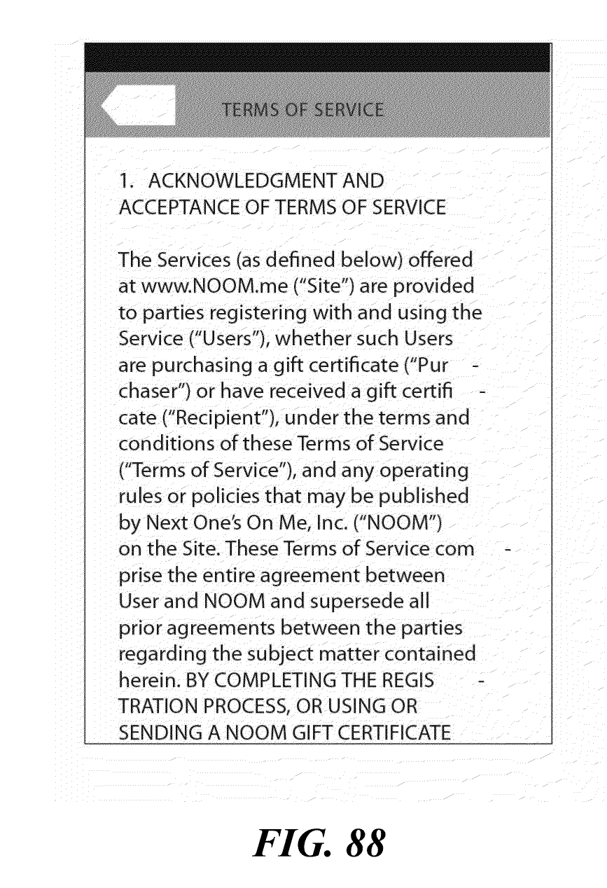

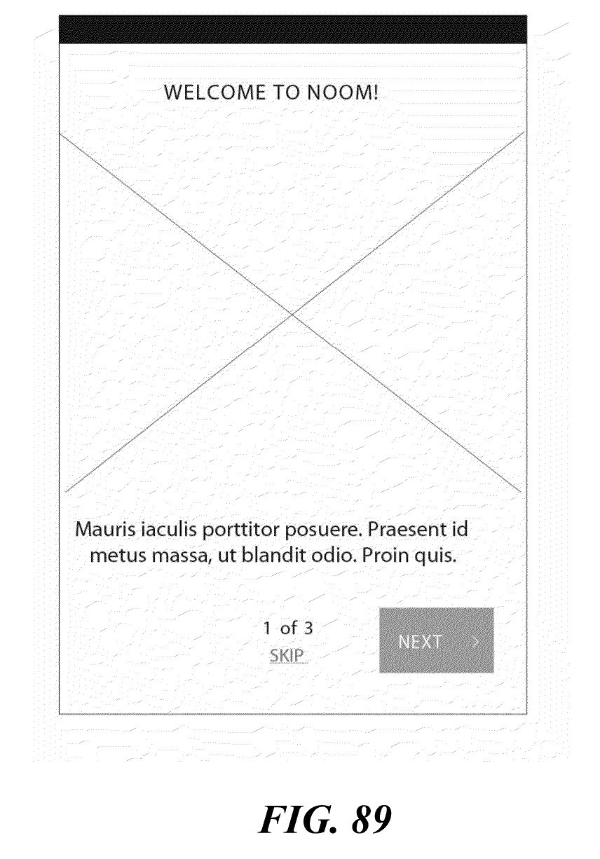

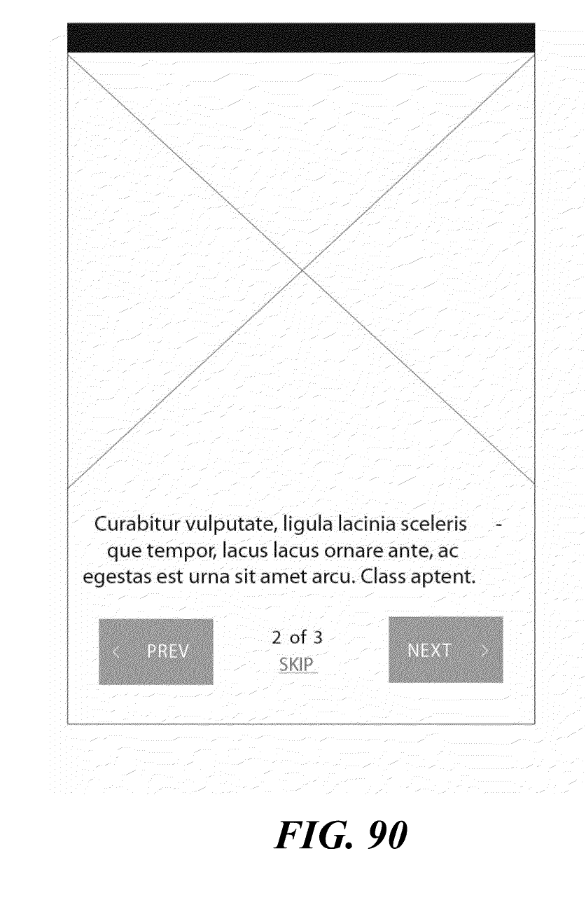

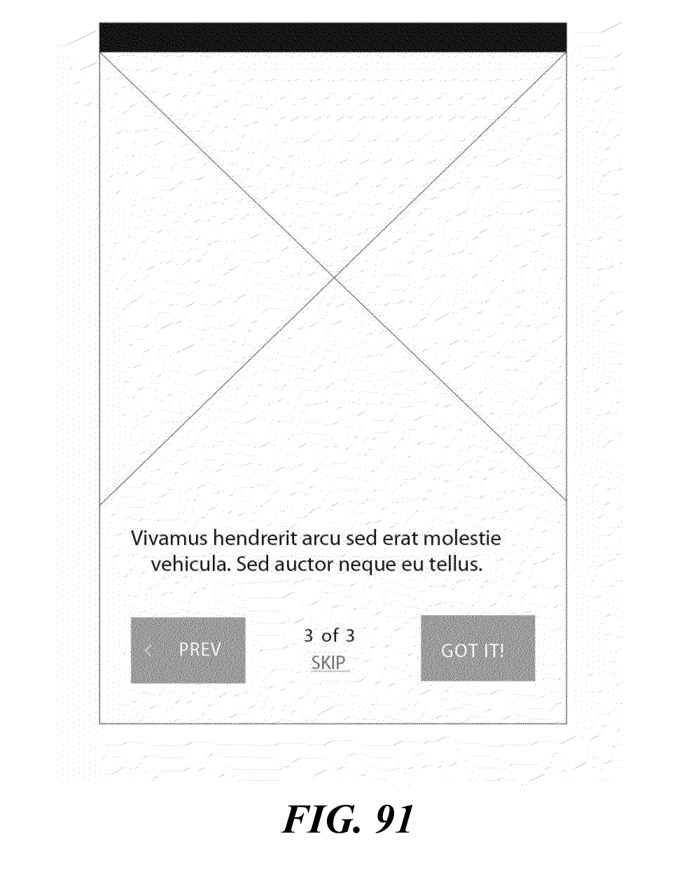

In some embodiments, these pages appear in succession without any action required on the part of the user. For example, a suitable time delay between each rendering may be defined in the software. In other embodiments, the user may cause the software to advance to the next page by clicking on a suitable feature, field or hyperlink, such as the next tab 263 in FIGS. 89 and 90, or through a suitable mouse click, keyboard entry or other appropriate gesture. In a similar manner, the user may also cause the software to return to a previously displayed page. For example, the user may accomplish this by selecting the previous tab 265 in FIGS. 90-91. Similarly, the user may skip the introductory pages 251, 253 and 255 or terminate the introduction subroutine 201 by undertaking a suitable action, such as selecting the skip hyperlink 267 in FIGS. 89-91 or the skip tab 269 in FIGS. 4-5, or by selecting the “got it!” 271 tab in FIG. 91 or in FIG. 6.

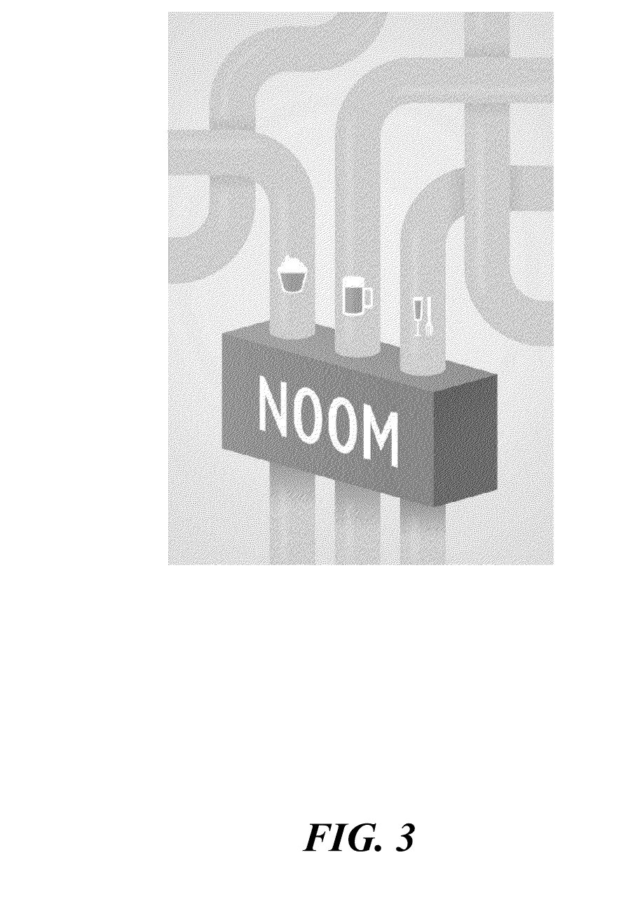

In some embodiments, the introduction subroutine 201 may also feature a series of splash pages, such as splash pages 273 and 275 of FIGS. 2-3, that are rendered in succession on the user's display. These splash pages may be displayed, for example, as part of the introduction subroutine 201, in which case they are preferably rendered before the introductory pages 251, 253 and 255 depicted, respectively, in FIGS. 89-91 or the corresponding pages 257, 259 and 261 depicted, respectively, in FIGS. 4-6. In some embodiments, these splash pages may also be displayed each time the user launches the software.

Referring again to FIG. 89, if the Boolean variable 203 representing whether the user is using the software for the first time has the value “false”, then the software proceeds to determine whether a the user is currently logged into the service or website that the software operates in conjunction with. Preferably, this is determined by ascertaining whether a Boolean variable 205 representing whether the user is currently logged has the value “true” or “false”. If this Boolean variable 205 has the value “false”, then the user is not logged in, and is directed to the appropriate login page in the home subroutine 301 (see FIG. 90). If this Boolean variable 205 has the value “true”, then the user is logged in, and is returned to the last accessed page (or to a designated default page, if the previously accessed page is no longer available).

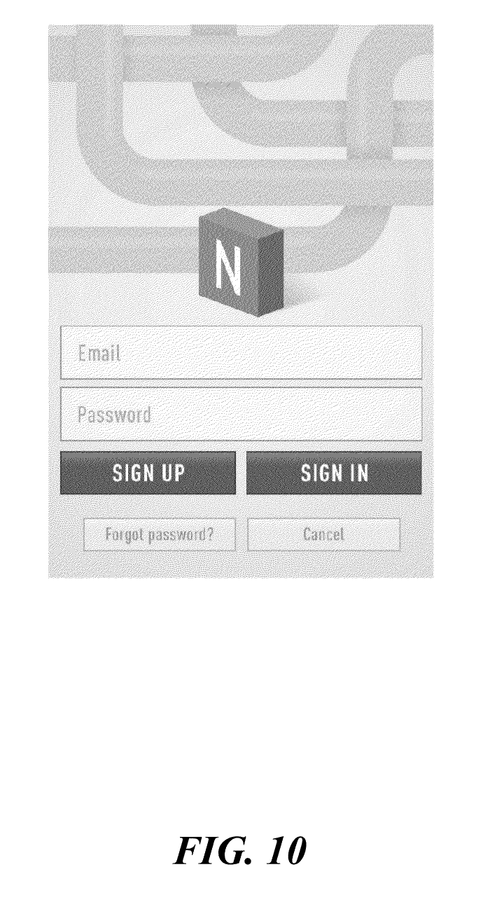

Referring now to Page 89, if the user is not currently signed in, the introduction subroutine 201 directs the user to a sign-in page 351 (see FIG. 10) or 352 (see FIG. 23). The sign-in page 351 includes email 353 and password 355 fields where the user can sign in by entering an email and password, respectively, which are associated with the user's account. After entry of the appropriate information in these fields, the user may then complete the sign in process by selecting the sign in tab 357, or by hitting the return button on a keyboard or performing an equivalent action or gesture. At any time, the user may cancel the sign in process by selecting the cancel tab 359. The user may also obtain help with a forgotten password by selecting the “forgot password” tab 361 (see FIG. 10).

A sign up tab 363 is provided which the user can select if the user does not currently have an account. Selecting this tab launches a subroutine in which the user provides suitable information to open an account.

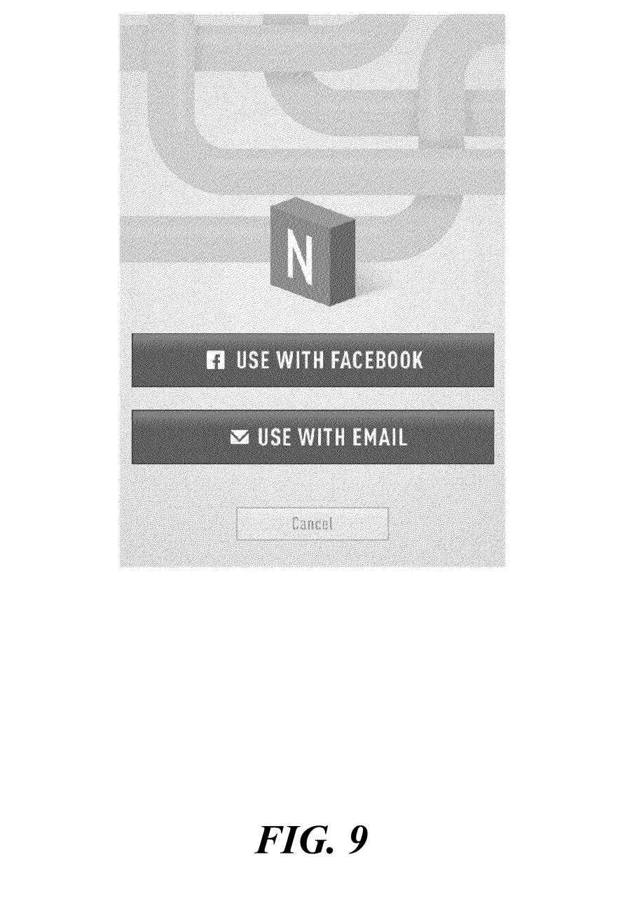

Preferably, users of the system depicted will also have the option of signing in with a Facebook account or an email account. This option may be presented on the sign in page, as seen in sign in page 352 of FIG. 23. Alternatively, a separate page sign in option page, such as the sign in option page 365 of FIG. 9, may be provided for this purpose. In the latter case, the introduction subroutine 201 preferably directs the user to the sign in option page 365 first, and then to the corresponding sign-in page 351 (see FIG. 10) after the user has made a selection. In either case, the user may be presented with an email sign in tab 367 if the user wishes to sign in using an email account, or a website sign in tab 369 if the user wishes to sign in using a website (such as, for example, a social media website like Facebook).

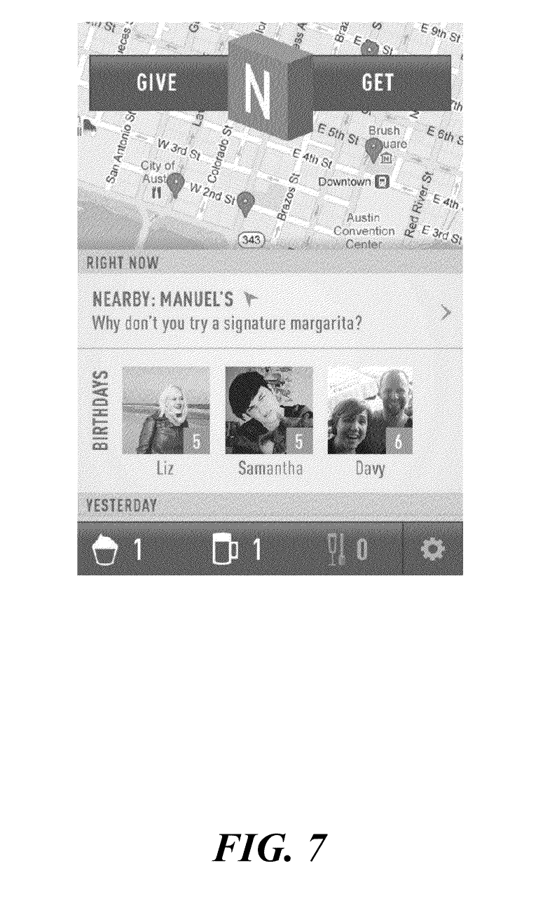

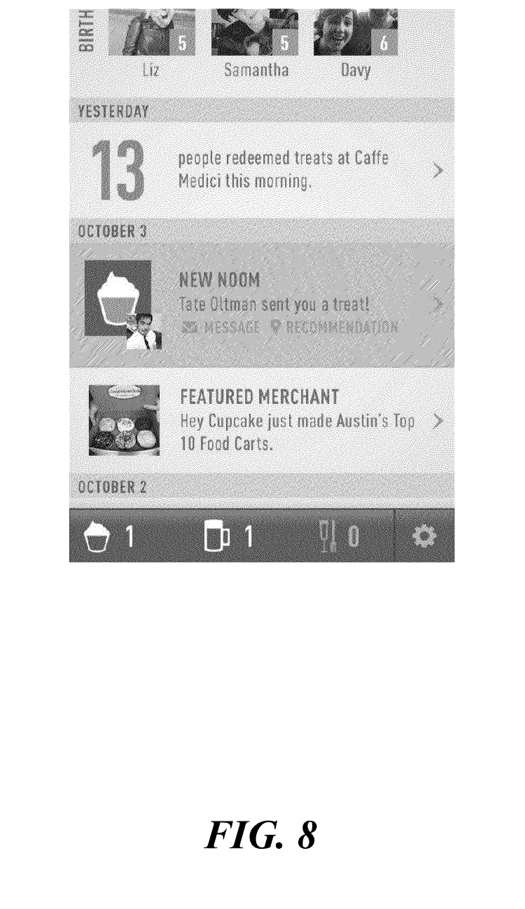

After the user is signed in, the introduction subroutine 201 directs the user to the user's home page 371 (see FIG. 7-8) or 372 (see FIGS. 24-25). The home page 371, 372 includes a scrollable news feed 373. The news feed 373 apprises the user of various events such as birthdays or the usage of tokens (frequently termed “NOOMs” in the illustrated examples) which were gifted by the user, and also notifies the user of nearby merchants that accept the tokens. Preferably, each item 374 on the news feed may be expanded when it is selected, thus allowing the user to obtain further information or to take an appropriate action. For example, selecting an item 374 pertaining to a person's birthday may cause the item 374 to expand and reveal an option to send that person a token (e.g., by launching the token gifting subroutine 601).

The home page 371, 372 further includes a token redemption tab 375 and a token gifting tab 376 whereby the user can launch, respectively, the token redemption subroutine 501 and the token gifting subroutine 601. The home page 371, 372 also includes a browsing tab 377 which launches the browsing subroutine 401.

The home page 371, 372 further includes a token toolbar 379 which is preferably disposed at the bottom of the page. The token toolbar 379 includes information, preferably in a graphical format, about the number and kinds of tokens that have been received (in some cases, and/or given) by the user. Thus, for example, the token toolbar 379 may include a series of icons or other indicia 381 representing different categories of tokens (e.g., snacks, drinks, dinner) and a running total 382 of the number of tokens the user has accumulated (in some cases, and/or given) in each category.

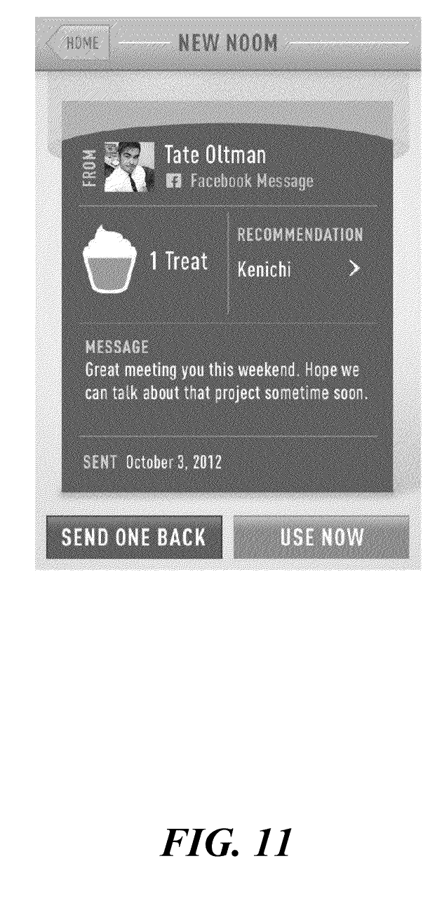

FIGS. 11 and 27 depict examples of items 374 on the news feed that have been selected, thus causing them to expand. In each of the particular cases depicted, the expanded page 383, 384 (see FIGS. 10 and 27, respectively) notifies the user that they have been gifted with a token and identifies the giver. The expanded page 383, 384 further contains a message 385 from the giver, and also contains a “use now” tab 387 which launches the token redemption subroutine 501. The expanded page may also include a “send one back” tab 389 (see FIG. 11) which allows the user to send a token back to the giver by launching the token gifting subroutine 601, or a thanks tab 391 (see FIG. 27) which allows the user to send a thank you message to the giver (as, for example, by opening a message window, which is preferably automatically populated with the giver's necessary contact information).

As seen in FIG. 11, the expanded page 383 may also include an icon 393 or picture corresponding to the user, an identification 394 of the type of token being gifted, and a recommendation 395 provided by the giver. The expanded page 383 may also include a home tab 392 which launches the home subroutine 301.

In the embodiment depicted, the recommendation is expandable into a separate page 396 which includes information about the item being recommended, a token redemption tab 397 which, when selected, launches the token redemption subroutine 501, and a browsing tab 398 which launches the browsing subroutine 401.

FIG. 90 depicts the browsing subroutine 401 utilized in the embodiment depicted in FIGS. 2-88. The browsing subroutine 401 commences at the main browsing widow 431 depicted in FIG. 28. The main browsing widow 431 preferably includes a map 433 showing the user's current location (or most recently recorded location). The map 433 may be populated with selectable icons 435 corresponding to the locations of merchants that accept tokens, and more preferably, with selectable icons 435 corresponding to the locations of merchants that the user has redeemable tokens for. Preferably, the icons 435 are color-coded or otherwise distinguished to indicate the type of redeemable token the user has for that merchant or, in some embodiments, the number of tokens.

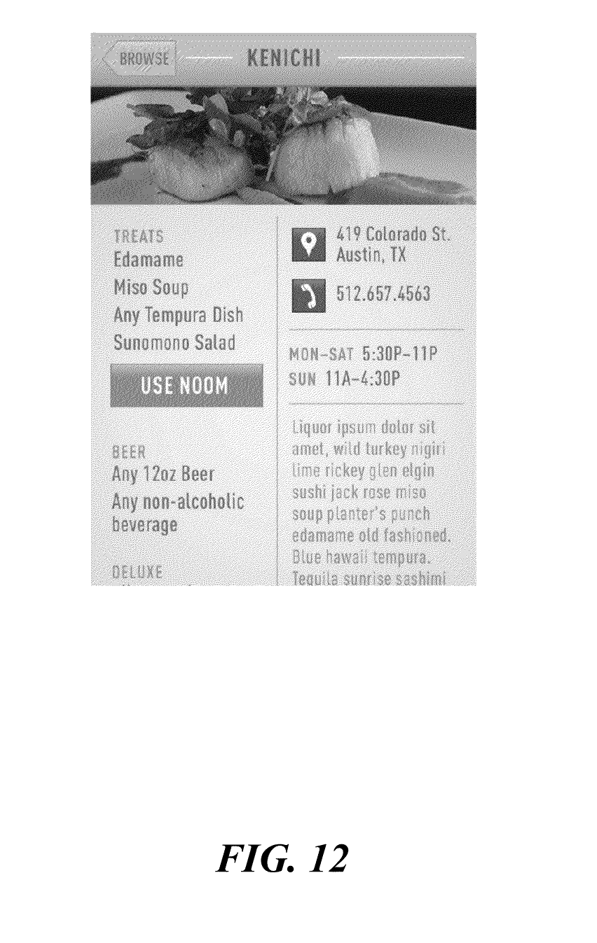

As seen in FIG. 29, in the particular embodiment depicted, when an icon 435 is selected by the user, a pop-up window 437 appears which provides some information about the vendor. This information may include, for example, the name and address of the vendor, the hours of operation for the vendor, and the type of tokens which may be redeemed at the vendor. The pop-up window 437 may include a window portion 439 which is expandable, or which launches another window with more detailed information about the vendor. Thus, for example, in the case which is depicted, the window portion 439 launches the window depicted in FIG. 12.

The main browsing widow 431 preferably also includes a browsing toolbar 441. The browsing toolbar 441 is preferably disposed at the top of the window. The browsing toolbar 441 preferably includes an expandable menu of cities 443 in which tokens are redeemable (shown in expanded form in FIG. 30). As seen in FIG. 31, selection of a city from the expandable menu of cites 443 causes the map 433 to be re-centered in the window, and the title on the expandable menu of cites 443 is updated to reflect the selected city. In some embodiments, a location services window 444 may be spawned from which the user can select a city to browse, and which reminds the user (if applicable) to enabled location services on their technology platform. The browsing toolbar 441 also preferably includes a back tab 447, returns the user to the previous page (in this case, the user's home page).

The browsing toolbar 441 also includes an expandable list of vendors 445 in the currently selected city which accept tokens. When the expandable list of vendors 445 is selected, it expands as shown in FIG. 32 to show further information about the vendor and its locations. If the vendor has multiple locations, selection of the vendor launches a window 449, as depicted in FIG. 33, which includes a listing of each location 451. Each of the listed locations 451 may also be expandable to provide further information about that location, as indicated in the scrollable window 453 of FIGS. 34-35. Such information preferably includes the street address of the selected vendor location 451 and its hours of operation, along with other information deemed useful to consumers.

As seen in FIGS. 34-35, the window 453 is also preferably equipped with a mapping functionality 455 which, when selected, preferably launches an interactive window depicting the geographical location of the selected vendor location 451. The window 453 is also preferably equipped with a calling feature 457 which allows the user to place a call to the selected vendor location 451. The window 453 is also preferably equipped with a gifting tab 459 which allows the user to give someone a token for the specified vendor. Finally, the window 453 is also preferably equipped with a “use now” tab 461 which allows the user to redeem a token at the current location of the vendor.

The browsing toolbar 441 of the main browsing window 431 (see FIGS. 28-31) also includes a search toolbar 463 equipped with a field in which the user can enter suitable queries, such as search terms. As seen in FIG. 36, when the search toolbar 463 is selected (e.g., by clicking inside of the field), it launches a window 465 equipped with a virtual keyboard 467 that the user can utilize to make an entry, and a results field 469 in which the corresponding results are displayed. Preferably, the results field 469 is populated in real time as the user is entering the search terms, thus avoiding the need for the user to enter any more information than is necessary. Each of the results 471 is preferably expandable to provide further information on the result. Thus, in the particular example depicted, the result is expandable into the window 396 depicted in FIG. 12.

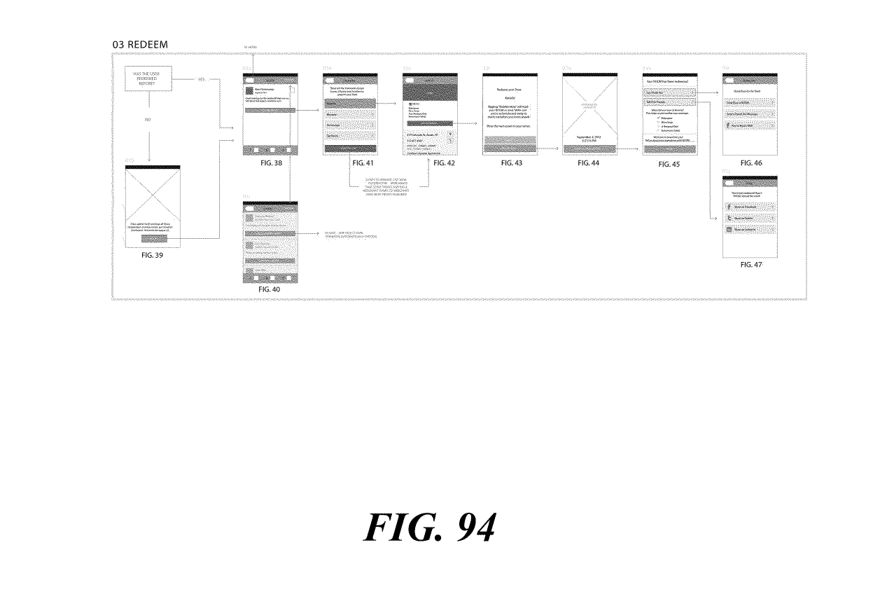

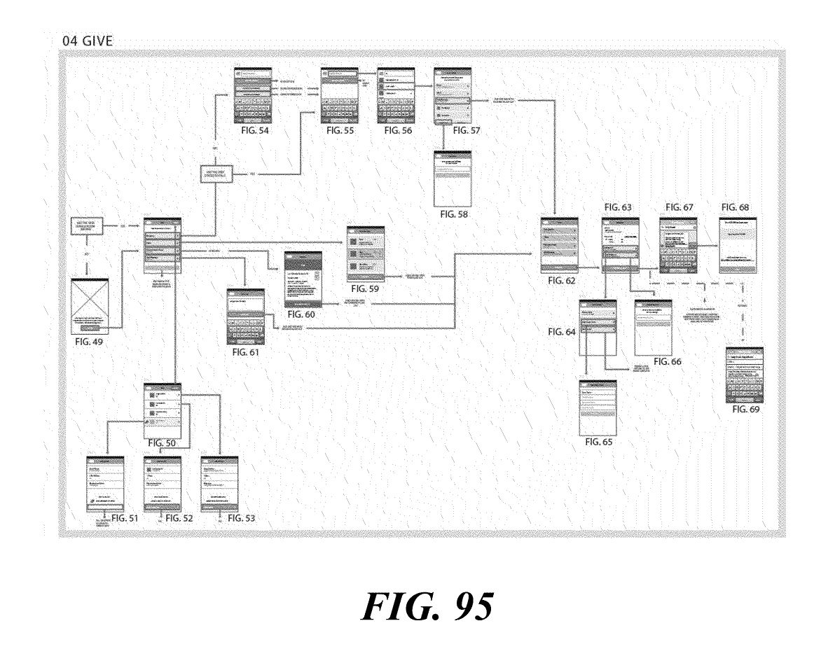

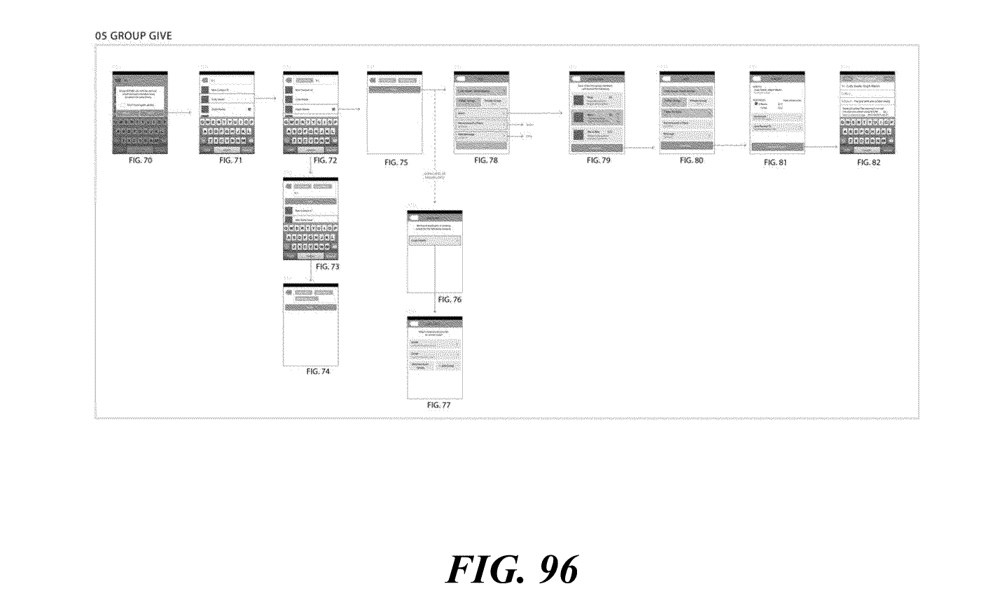

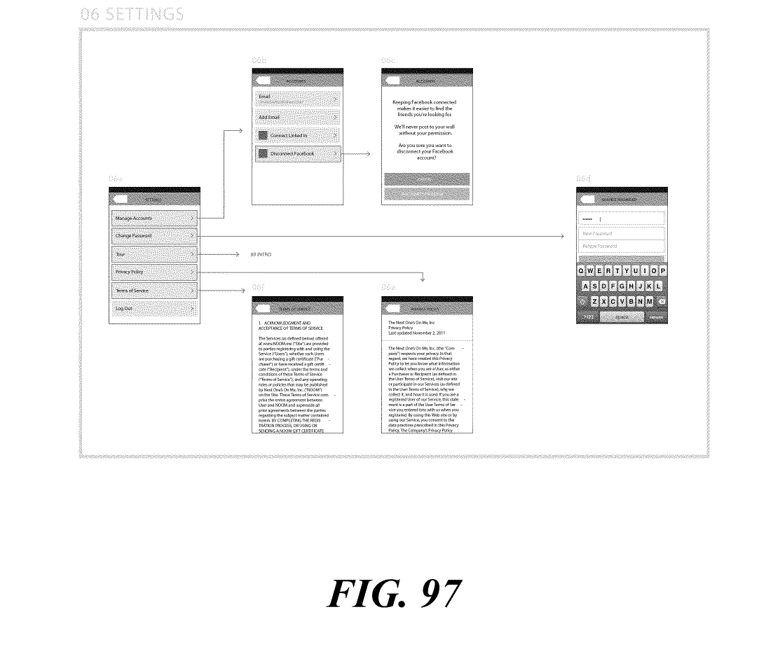

FIG. 94 depicts the token redemption process in the embodiment described above; FIG. 95 depicts the token gifting process; FIG. 96 depicts the group token gifting process; and FIG. 97 depicts the manner in which settings are made.

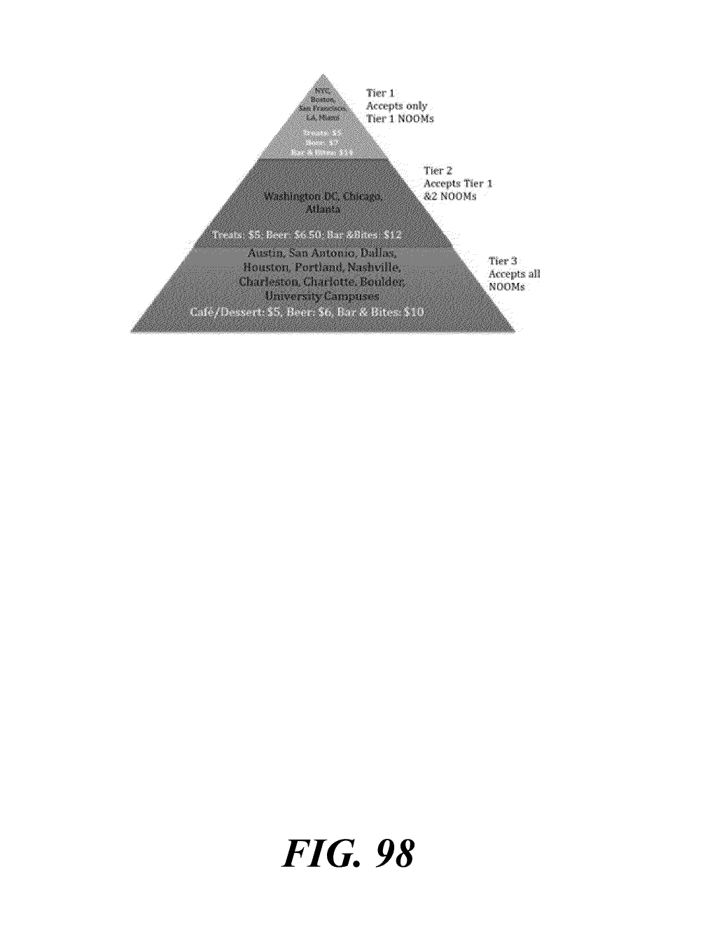

As illustrated in FIG. 98, token pricing is preferably tiered by geography. Hence, to the extent that market prices for the defined categories of goods or services differ geographically, the pricing of gifts for each category will be tiered by location to reflect this disparity. The giver's selection of a city dictates the price that the system displays. The redemption process allows redemption of all tokens in the recipient's token bank that are at least as much as the standard pricing in that location's tier. By way of illustration, this means that someone from New York who is visiting a Tier 2 or 3 city can use their tokens to try out a bar because New York has the highest pricing. Alternatively, an Austin token may not be eligible for redemption in NYC because it is of lower monetary value. Without the tiered structure, there would be an opportunity for users to engage in arbitrage pricing.

Both redemption and merchant selection are preferably triggered by a Global Positioning Satellite (GPS) system. The software which implements the methodologies disclosed herein (which may be a web-based service and/or a client installed on a user's device) stores a recipient's tokens in their account and, by way of GPS, knows when the recipient is in the vicinity of an establishment that accepts the tokens. The software also preferably shows the categories eligible for redemption and displays a map which is populated by places that offer categories that the user has in their bank. To redeem a token, the recipient accesses the platform, and selects where they are located and what they are redeeming. This triggers the return of a redemption page that lists the product, merchant and time of redemption. This page functions as an e-gift certificate.

The recipient then shows the screen to the merchant, who will ensure that the name of the establishment is listed and notes the product or service being redeemed. The merchant will also confirm the time stamp to ensure that the token has only recently been accessed. The redemption screen will feature an animation to ensure users do not create fraudulent screenshots. The merchant then indicates that the transaction is finished by undertaking some suitable action (such as clicking an “I'm done” button on a display), thereby terminating access to the page. A receipt screen is then returned. The recipient screen preferably includes a timing feature which may be, for example, a time stamp or a timer (which may count up or down). This page can be used to certify redemption if the redemption screen is prematurely terminated on accident. The software system then records the event and logs the owed amount in the merchant's account. Payment for redeemed tokens will preferably be sent to each merchant in lump sums at negotiated intervals.

The user interface provided by the software is preferably account-centric. Gifts are sent to the recipient's email address or via SMS, Facebook, or through other social networks such as Google+, Linkedin or Twitter which provide unique identifiers for each account. When a gift is given, an account is simultaneously created for each unique user not already in the company's database, creating a very quick user account set up. The token can be redeemed once the recipient completes an account set-up process by choosing a password or signing in with preestablished account credentials, such as those associated with a Facebook or Yahoo! account.

If the user is not an existing user and chooses not to sign in via pre-established account credentials, the user may be asked to enter their full name, email or phone number (whichever piece of information is missing), birthday, gender and zip code. The user is also asked to select a password. In the event that a user already has an account under a different email address or phone number, the two accounts may be readily merged.

Recipients can redeem tokens by following a link from the delivery message, or by opening a client resident on their Smartphone or other mobile technology platform. It is not necessary to have the native application downloaded onto the user's mobile technology platform in order to use the gifting system, since the token preferably links to a mobile web application. However, tokens are only accessible to users equipped with web-enabled platforms. If a gift is sent to a recipient without a web-enabled platform, the recipient is preferably given the option to decline the gift and have the gift returned to the giver and deposited into the giver's own bank (preferably less handling fees).

The system is also preferably equipped with a merchant interface which gives merchants a real time view of token redemptions that are occurring in their store, balances outstanding, and the history of redemptions. The merchant's ability to track redemptions in real time helps address concerns of fraud and provides a convenient way to verify activity.

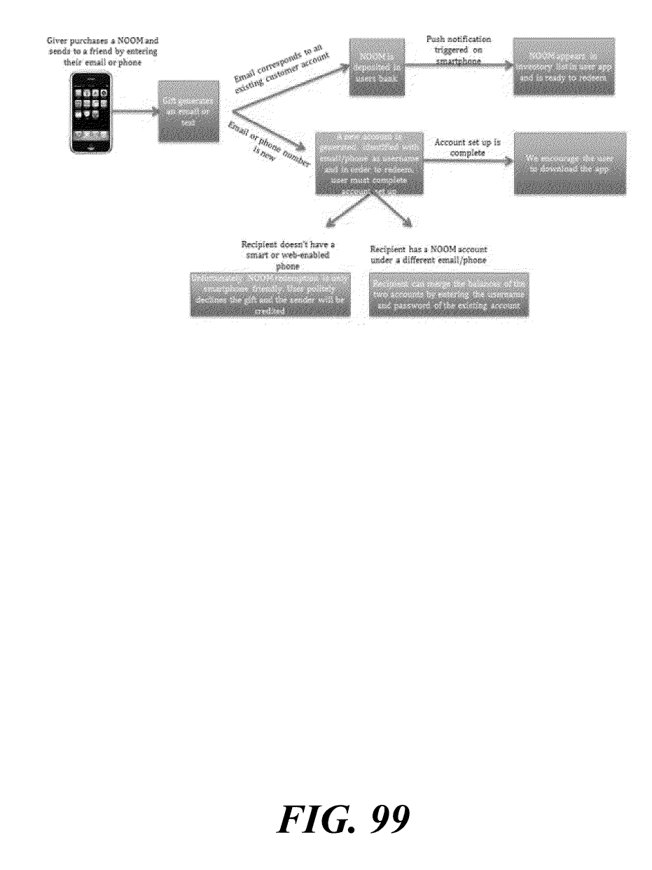

FIG. 99 illustrates the general process flow of a preferred embodiment of a method in accordance with the teachings herein for sending a token. Associated screenshots for this process may be found in the embodiments described above.

The associated screenshots for the user view for a preferred embodiment of the token redemption process are depicted in FIG. 94. As seen therein, a user can view possible redemption points from a list or map and can filter by popularity, proximity or product. The list and map are both determined by the stock of tokens the user has in their token bank as well as the user's current location. The recipient redeems their gift by using the map or list to select the establishment where they wish to use a token. Their selection tells the token provider whom to pay, and triggers a one-time redemption screen that the user displays to the merchant. The merchant acknowledges the screen and gives the user the requested product or service. The system is preferably equipped with a timing feature for fraud prevention purposes.

As previously noted, some of the systems and methodologies described herein may be implemented by way of an application or client, which may be made available to consumers as both a mobile web application and a native application. Preferably, both species of the application provide the same look and feel to consumers. It is also preferred that the redeemer does not have to download the application in order to redeem a token.

The systems and methodologies described herein may be utilized for various occasions. For example, they may be utilized for traditional gifting occasions, such as birthdays and holidays, special occasions, when congratulations are due, or for everyday thank yous.

The systems and methodologies described herein may also be utilized in professional contexts, such as employee appreciation, employee moral boosters, event planning, and colleague appreciation.

The systems and methodologies described herein may also be utilized in commercial contexts. For example, they may be used to express client/vendor appreciation, or in conjunction with product recommendations, vendor promotions or hotel hospitality.

The systems and methodologies described herein may also be utilized for personal interactions. These may include flirting, friendly wagers, repaying favors/squaring up, apologies or cheer-me-ups.

The systems and methodologies described herein may also be utilized in collegiate or studying contexts. For example, they may be utilized as study aids, to say congratulations, as thanks for a recommendation, or as part of Greek life interactions.

The systems and methodologies described herein may also be utilized for spontaneous gifting and for miscellaneous purposes. These may include, for example, “just because” or “thinking of you” occasions, as a source of humor, or simply to create good karma. Moreover, in some embodiments, the systems and methodologies disclosed herein may be white labeled, thus allowing them to be used by a merchant as a means of selling gift certificates to their establishment or platform.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

1. A method for exchanging gifts, comprising:
registering with a system which provides electronic tokens redeemable at any member of a set of merchants;
purchasing an electronic token from the service;
designating a gift category for the token, such that the token is redeemable for a product or service within the designated category at any member of the set of merchants which offers a product or service within the designated category; and
sending the token to a designated recipient via an electronic message.

2. The method of claim 1, wherein said designated category is selected from the group consisting of food and beverages.

3. The method of claim 1, wherein the electronic token is redeemable on a mobile technology platform.

4. The method of claim 1, wherein the electronic token is only redeemable on a mobile technology platform.

5. The method of claim 1, wherein the recipient redeems their gift by identifying, on a map or list, a merchant from the set of merchants where the recipient wishes to redeem the token.

6. The method of claim 5, wherein the recipient's selection of a merchant causes the system to process payment to the designated merchant.

7. The method of claim 6, wherein the recipient redeems their gift by identifying, on a map, a merchant from the set of merchants where the recipient wishes to redeem the token.

8. The method of claim 7, wherein the recipient identifies the merchant on a map on a mobile technology platform.

9. The method of claim 7, wherein the recipient identifies the merchant on a list on a mobile technology platform.

10. The method of claim 5, wherein the recipient's selection of a merchant triggers the display of a token redemption screen.

11. The method of claim 10, wherein the recipient displays the redemption screen to the merchant in order to obtain a product or service in the designated gift category.

12. The method of claim 10, wherein the merchant acknowledges display of the screen prior to dispensing the product or service to the recipient.

13. The method of claim 1, wherein the value associated with a token in a given gift category is geographically tiered to reflect geographical differences in the cost of goods or services in that gift category.

14. The method of claim 13, wherein the token is redeemable for a product or service within the designated gift category at any member of the set of merchants which offers a product or service within the designated category and which is in a geographical tier of the same or lesser value than the one for which the token was issued.

15. The method of claim 1, wherein the token has a fixed redemption for each gift category.

16. The method of claim 15, wherein the fixed redemption rate is agreed upon by each member of the set of merchants.

17. A system for exchanging gifts, comprising:
a first set of servers which contains at least one member, each of which (a) issues, upon demand and receipt of payment, electronic tokens which are redeemable at any member of a predefined set of merchants, and (b) processes payment to a merchant selected for redemption of a token; and
a plurality of mobile technology platforms, each of which is in communication with a member of said first set of servers over a network, and each of which is equipped with a tangible medium having suitable programming instructions recorded therein which, upon execution, cause the mobile technology platform to undertake actions which result in (a) purchasing an electronic token from the service; (b) designating a gift category for the token, such that the token is redeemable for a product or service within the designated category at any member of the set of merchants which offers a product or service within the designated category; and (c) sending the token to a designated recipient via an electronic message.

18. The system of claim 17, further comprising:
a second set of servers, each member of which (a) is associated with one of the predefined set of merchants, and (b) interacts with a member of said first set of servers to process payment to the merchant associated with redemption of a token.

19. A method for processing payments of goods or services, comprising:
registering with a system which provides electronic tokens redeemable at any member of a set of merchants;
receiving a request for redemption of a token issued by the system in conjunction with the purchase of goods or services;
accepting the request;
receiving payment from the system for redemption of the token; and
applying the payment to the cost of the requested goods or services.

20. (canceled)
